(19) United States
(12) Patent Application Publication
(10) Pub. No.: US 2025/0261124 A1
(43) Pub. Date: Aug. 14, 2025

(54) PER TRANSMISSION AND RECEPTION POINT POWER CONTROL FOR UPLINK SINGLE FREQUENCY NETWORK OPERATION

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/854,343

(22) PCT Filed: May 18, 2022
(86) PCT No.: PCT/CN2022/093451

§ 371 Date: Oct. 4, 2024

(51) Int. Cl. H04W 52/14; H04W 52/08; H04W 52/36; H04W 72/231

(52) U.S. Cl. CPC H04W 52/146; H04W 52/08; H04W 52/365; H04W 72/231

(57) ABSTRACT

Methods, systems, and devices for wireless communications are described, the described techniques provide for per-transmission and reception point (TRP) power control for uplink transmissions using a single frequency network (SFN) configuration. A UE that establishes communications with a network via two or more TRPs using an SFN configuration for uplink transmissions may determine respective uplink transmission power levels for uplink transmissions to each TRP. The UE may transmit uplink transmissions to the two or more TRPs in accordance with the determined respective uplink transmission power levels. In some cases, the UE may receive a downlink control information message that includes transmit power command fields for each respective TRP based on transmission configuration indictor states associated with each TRP. In some cases, the UE may determine a set of power control parameters associated with each TRP. In some cases, the UE may transmit power headroom reports for each TRP.

### CROSS REFERENCE

The present Application is a 371 national phase filing of International PCT Application No. PCT/CN2022/093451 by YUAN et al., entitled “PER TRANSMISSION AND RECEPTION POINT POWER CONTROL FOR UPLINK SINGLE FREQUENCY NETWORK OPERATION,” filed May 18, 2022, which is assigned to the assignee hereof, and which is expressly incorporated by reference in its entirety herein.

### FIELD OF TECHNOLOGY

The present disclosure relates to wireless communications, including per transmission and reception point power control for uplink single frequency network operation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support per transmission and reception point (TRP) power control for uplink single frequency network (SFN) operation. For example, the described techniques provide for per-TRP power control for uplink transmissions using an SFN configuration. A UE that establishes a communications link with a network via two or more TRPs (e.g., in a multiple TRP (mTRP) system) using an SFN configuration for uplink transmissions may determine respective uplink transmission power levels for uplink transmissions to each TRP. The UE operating according to the SFN configuration may transmit uplink transmissions to the two or more TRPs in accordance with the determined respective uplink transmission power levels. In some cases, the UE may receive a downlink control information (DCI) message that includes transmit power command fields for each respective TRP. In some cases, the UE may determine a set of power control parameters associated with each TRP based on transmission configuration indicator (TCI) states associated with each TRP. In some cases, the UE may transmit power headroom reports for each TRP (e.g., based on measured reference signals received from the TRPs). The UE may receive, from the network, an indication of uplink power levels associated with the TRPs based on the reported power headroom reports.

A method for wireless communications at a UE is described. The method may include establishing a communications link with a network via a first TRP and a second TRP according to a single frequency network configuration, determining a first uplink power level for first uplink transmissions to the network via the first TRP and a second uplink power level for second uplink transmissions to the network via the second TRP, and transmitting the first uplink transmissions to the first TRP in accordance with the first uplink power level and the second uplink transmissions to the second TRP in accordance with the second uplink power level.

An apparatus for wireless communications at a UE is described. The apparatus may include a processor, memory coupled with the processor, and instructions stored in the memory. The instructions may be executable by the processor to cause the apparatus to establish a communications link with a network via a first TRP and a second TRP according to a single frequency network configuration, determine a first uplink power level for first uplink transmissions to the network via the first TRP and a second uplink power level for second uplink transmissions to the network via the second TRP, and transmit the first uplink transmissions to the first TRP in accordance with the first uplink power level and the second uplink transmissions to the second TRP in accordance with the second uplink power level.

Another apparatus for wireless communications at a UE is described. The apparatus may include means for establishing a communications link with a network via a first TRP and a second TRP according to a single frequency network configuration, means for determining a first uplink power level for first uplink transmissions to the network via the first TRP and a second uplink power level for second uplink transmissions to the network via the second TRP, and means for transmitting the first uplink transmissions to the first TRP in accordance with the first uplink power level and the second uplink transmissions to the second TRP in accordance with the second uplink power level.

A non-transitory computer-readable medium storing code for wireless communications at a UE is described. The code may include instructions executable by a processor to establish a communications link with a network via a first TRP and a second TRP according to a single frequency network configuration, determine a first uplink power level for first uplink transmissions to the network via the first TRP and a second uplink power level for second uplink transmissions to the network via the second TRP, and transmit the first uplink transmissions to the first TRP in accordance with the first uplink power level and the second uplink transmissions to the second TRP in accordance with the second uplink power level.

Some examples of the method, apparatuses, and non-transitory computer-readable medium described herein may further include operations, features, means, or instructions for receiving a DCI message indicating a first transmit power command associated with the first TRP and a second transmit power command associated with the second TRP, where determining the first uplink power level and the second uplink power level may be based on the first transmit power command and the second transmit power command.

Some examples of the method, apparatuses, and non-transitory computer-readable medium described herein may further include operations, features, means, or instructions for determining that a first field indicating the first transmit power command may be associated with a first TCI state of a TCI codepoint and a second field indicating the second transmit power command may be associated with a second TCI state of the TCI codepoint based on an order of the first field and the second field within the DCI message.

Some examples of the method, apparatuses, and non-transitory computer-readable medium described herein may further include operations, features, means, or instructions for determining that a first field indicating the first transmit power command may be associated with a first TCI state of a first closed loop index in a TCI codepoint and a second field indicating the second transmit power command may be associated with a second TCI state of a second closed loop index in the TCI codepoint based on an order of the first field and the second field within the DCI message.

Some examples of the method, apparatuses, and non-transitory computer-readable medium described herein may further include operations, features, means, or instructions for identifying, based on a first TCI state associated with the first TRP and a second TCI state associated with the second TRP, a first set of power control parameters associated with the first TRP and a second set of power control parameters associated with the second TRP, where determining the first uplink power level for the first uplink transmissions and the second uplink power level for the second uplink transmissions may be based on the first set of power control parameters and the second set of power control parameters.

Some examples of the method, apparatuses, and non-transitory computer-readable medium described herein may further include operations, features, means, or instructions for receiving control signaling indicating the first set of power control parameters may be associated with the first TCI state and the second set of power control parameters may be associated with the second TCI state based on a TCI codepoint including the first TCI state and the second TCI state.

Some examples of the method, apparatuses, and non-transitory computer-readable medium described herein may further include operations, features, means, or instructions for receiving control signaling indicating two sets of power control parameters for each uplink bandwidth part of a set of multiple uplink bandwidth parts, where the identifying may be based on an uplink bandwidth part of the set of multiple uplink bandwidth parts associated with the first uplink transmissions and the second uplink transmissions.

In some examples of the method, apparatuses, and non-transitory computer-readable medium described herein, the first set of power control parameters includes a first default set of power control parameters and the second set of power control parameters includes a second set of default power control parameters.

Some examples of the method, apparatuses, and non-transitory computer-readable medium described herein may further include operations, features, means, or instructions for transmitting a message including a first power headroom report associated with the first TRP and a second power headroom report associated with the second TRP.

Some examples of the method, apparatuses, and non-transitory computer-readable medium described herein may further include operations, features, means, or instructions for receiving control signaling indicating for the UE to report the first power headroom report and the second power headroom report.

Some examples of the method, apparatuses, and non-transitory computer-readable medium described herein may further include operations, features, means, or instructions for receiving control signaling scheduling an uplink transmission using the single frequency network configuration, where the first power headroom report and the second power headroom report include real power headroom reports associated with the uplink transmission.

Some examples of the method, apparatuses, and non-transitory computer-readable medium described herein may further include operations, features, means, or instructions for receiving control signaling scheduling an uplink transmission using a transmission configuration different from the single frequency network configuration, where the first power headroom report includes a real power headroom report associated with the uplink transmission and the second power headroom report includes a virtual power headroom report.

In some examples of the method, apparatuses, and non-transitory computer-readable medium described herein, establishing the communications link with the network according to the single frequency network configuration may include operations, features, means, or instructions for receiving a first set of parameter values for a first set of antenna elements of the UE for uplink transmissions to the first TRP and a second set of parameter values for a second set of antenna elements of the UE for uplink transmissions to the second TRP during a same set of time and frequency resources.

A method for wireless communications at a network entity is described. The method may include establishing a communications link with a UE via a first TRP and a second TRP according to a single frequency network configuration, transmitting, to the UE, power management signaling configured to support the UE determining a first uplink power level for first uplink transmissions to the first TRP and a second uplink power level for second uplink transmissions to the second TRP, and receiving, from the UE at least in part in response to the transmitted power management signaling, the first uplink transmissions via the first TRP in accordance with the first uplink power level and the second uplink transmissions via the second TRP in accordance with the second uplink power level.

An apparatus for wireless communications at a network entity is described. The apparatus may include a processor, memory coupled with the processor, and instructions stored in the memory. The instructions may be executable by the processor to cause the apparatus to establish a communications link with a UE via a first TRP and a second TRP according to a single frequency network configuration, transmit, to the UE, power management signaling configured to support the UE determining a first uplink power level for first uplink transmissions to the first TRP and a second uplink power level for second uplink transmissions to the second TRP, and receive, from the UE at least in part in response to the transmitted power management signaling, the first uplink transmissions via the first TRP in accordance with the first uplink power level and the second uplink transmissions via the second TRP in accordance with the second uplink power level.

Another apparatus for wireless communications at a network entity is described. The apparatus may include means for establishing a communications link with a UE via a first TRP and a second TRP according to a single frequency network configuration, means for transmitting, to the UE, power management signaling configured to support the UE determining a first uplink power level for first uplink transmissions to the first TRP and a second uplink power level for second uplink transmissions to the second TRP, and means for receiving, from the UE at least in part in response to the transmitted power management signaling, the first uplink transmissions via the first TRP in accordance with the first uplink power level and the second uplink transmissions via the second TRP in accordance with the second uplink power level.

A non-transitory computer-readable medium storing code for wireless communications at a network entity is described. The code may include instructions executable by a processor to establish a communications link with a UE via a first TRP and a second TRP according to a single frequency network configuration, transmit, to the UE, power management signaling configured to support the UE determining a first uplink power level for first uplink transmissions to the first TRP and a second uplink power level for second uplink transmissions to the second TRP, and receive, from the UE at least in part in response to the transmitted power management signaling, the first uplink transmissions via the first TRP in accordance with the first uplink power level and the second uplink transmissions via the second TRP in accordance with the second uplink power level.

In some examples of the method, apparatuses, and non-transitory computer-readable medium described herein, transmitting the power management signaling may include operations, features, means, or instructions for transmitting a DCI message indicating a first transmit power command associated with the first TRP and a second transmit power command associated with the second TRP.

In some examples of the method, apparatuses, and non-transitory computer-readable medium described herein, transmitting the DCI message may include operations, features, means, or instructions for transmitting the DCI message including a first field indicating the first transmit power command may be associated with a first TCI state of a TCI codepoint and a second field indicating the second transmit power command may be associated with a second TCI state of the TCI codepoint, where the first TRP may be associated with the first TCI state and the second TRP may be associated with the second TCI state based on an order of the first field and the second field within the DCI message.

In some examples of the method, apparatuses, and non-transitory computer-readable medium described herein, transmitting the DCI message may include operations, features, means, or instructions for transmitting the DCI message including a first field indicating the first transmit power command may be associated with a first TCI state of a first closed loop index in a TCI codepoint and a second field indicating the second transmit power command may be associated with a second TCI state of a second closed loop index in the TCI codepoint, where the first TRP may be associated with the first TCI state and the second TRP may be associated with the second TCI state based on an order of the first field and the second field within the DCI message.

In some examples of the method, apparatuses, and non-transitory computer-readable medium described herein, transmitting the power management signaling may include operations, features, means, or instructions for transmitting control signaling indicating that a first set of power control parameters may be associated with a first TCI state and a second set of power control parameters may be associated with a second TCI state based on a TCI codepoint including the first TCI state and the second TCI state, where the first TCI state may be associated with the first TRP and the second TCI state may be associated with the second TRP.

In some examples of the method, apparatuses, and non-transitory computer-readable medium described herein, transmitting the power management signaling may include operations, features, means, or instructions for transmitting control signaling indicating two sets of power control parameters for each uplink bandwidth part of a set of multiple uplink bandwidth parts, where an uplink bandwidth part of the set of multiple uplink bandwidth parts may be associated with the first uplink transmissions and the second uplink transmissions.

Some examples of the method, apparatuses, and non-transitory computer-readable medium described herein may further include operations, features, means, or instructions for receiving, from the UE, a message including a first power headroom report associated with the first TRP and a second power headroom report associated with the second TRP.

In some examples of the method, apparatuses, and non-transitory computer-readable medium described herein, transmitting the power management signaling may include operations, features, means, or instructions for transmitting control signaling indicating the first uplink power level and the second uplink power level.

Some examples of the method, apparatuses, and non-transitory computer-readable medium described herein may further include operations, features, means, or instructions for transmitting, to the UE, control signaling indicating for the UE to report the first power headroom report and the second power headroom report.

Some examples of the method, apparatuses, and non-transitory computer-readable medium described herein may further include operations, features, means, or instructions for transmitting, to the UE, control signaling scheduling an uplink transmission using the single frequency network configuration, where the first power headroom report and the second power headroom report include real power headroom reports associated with the uplink transmission.

Some examples of the method, apparatuses, and non-transitory computer-readable medium described herein may further include operations, features, means, or instructions for transmitting, to the UE, control signaling scheduling an uplink transmission using a transmission configuration different from the single frequency network configuration, where the first power headroom report includes a real power headroom report associated with the uplink transmission and the second power headroom report includes a virtual power headroom report.

### BRIEF DESCRIPTION OF THE DRAWINGS

FIG. 1 illustrates an example of a wireless communications system that supports per transmission and reception point (TRP) power control for uplink single frequency network (SFN) operation in accordance with one or more aspects of the present disclosure.

FIG. 2 illustrates an example of a network architecture that supports per transmission and reception point power control for uplink SFN operation in accordance with one or more aspects of the present disclosure.

FIG. 3 illustrates an example of a wireless communications system that supports per TRP power control for uplink SFN operation in accordance with one or more aspects of the present disclosure.

FIG. 4 illustrates an example of a process flow that supports per TRP power control for uplink SFN operation in accordance with one or more aspects of the present disclosure.

FIG. 5 illustrates an example of a process flow that supports per TRP power control for uplink SFN operation in accordance with one or more aspects of the present disclosure.

FIG. 6 illustrates an example of a process flow that supports per TRP power control for uplink SFN operation in accordance with one or more aspects of the present disclosure.

FIG. 7 illustrates an example of a process flow that supports per TRP power control for uplink SFN operation in accordance with one or more aspects of the present disclosure.

FIGS. 8 and 9 show block diagrams of devices that support per TRP power control for uplink SFN operation in accordance with one or more aspects of the present disclosure.

FIG. 10 shows a block diagram of a communications manager that supports per TRP power control for uplink SFN operation in accordance with one or more aspects of the present disclosure.

FIG. 11 shows a diagram of a system including a device that supports per TRP power control for uplink SFN operation in accordance with one or more aspects of the present disclosure.

FIGS. 12 and 13 show block diagrams of devices that support per TRP power control for uplink SFN operation in accordance with one or more aspects of the present disclosure.

FIG. 14 shows a block diagram of a communications manager that supports per TRP power control for uplink SFN operation in accordance with one or more aspects of the present disclosure.

FIG. 15 shows a diagram of a system including a device that supports per TRP power control for uplink SFN operation in accordance with one or more aspects of the present disclosure.

FIGS. 16 through 21 show flowcharts illustrating methods that support per TRP power control for uplink SFN operation in accordance with one or more aspects of the present disclosure.

### DETAILED DESCRIPTION

In some wireless communication systems, a user equipment (UE) may communicate with the network via two or more transmission and reception points (TRPs). In some cases, the UE may be configured to transmit uplink communications via a single frequency network (SFN) configuration. In an SFN configuration, a UE may be configured to transmit a same uplink transmission (e.g., a physical uplink control channel (PUCCH) transmission or a physical uplink shared channel (PUSCH) transmission) using a same frequency and/or time resource. In an uplink SFN configuration, the UE may transmit a same signal to multiple TRPs (e.g., mTRPs) using different beams for each of the multiple TRPs. Each TRP may be associated with a respective transmission configuration indicator (TCI) state. Currently, there is no configuration enabling per-TRP power control for uplink transmissions using an SFN configuration.

Aspects of the disclosure relate to per-TRP power control for uplink transmissions using an SFN. A UE that establishes communications with a network via two or more TRPs using an SFN configuration for uplink transmissions may determine respective uplink transmission power levels for uplink transmissions to each TRP. The UE operating according to the SFN configuration may transmit uplink transmissions to the two or more TRPs in accordance with the determined respective uplink transmission power levels.

In some cases, the UE may receive a downlink control information (DCI) message that includes transmit power command fields for each respective TRP. In some cases, the UE may determine which transmit power command field is associated with which TRP based on the TCI states associated with the TRPs and the order of the transmit power command fields within the DCI message. In some cases, the UE may determine a set of power control parameters associated with each TRP based on TCI states associated with each TRP. For example, control signaling received at the UE may indicate respective sets of power control parameters associated with each TCI state based on a TCI codepoint, and the UE may determine an uplink transmission power level based for the respective TRPs based on the sets of power control parameters associated with the respective TCI states. In some cases, the UE may transmit power headroom reports for each TRP (e.g., based on measured reference signals received from the TRPs). A power headroom value may indicate how much transmission power is available for the UE to use for an upcoming transmission, calculated as a difference between a maximum available transmission power and a demanded transmission power of for an upcoming transmission based on a set of power control parameters. The UE may receive an indication of uplink power levels for the TRPs from the network based on the reported power headroom reports.

Aspects of the disclosure are initially described in the context of wireless communications systems. Aspects of the disclosure are further illustrated by and described with reference to process flows, apparatus diagrams, system diagrams, and flowcharts that relate to per TRP power control for uplink SFN operation.

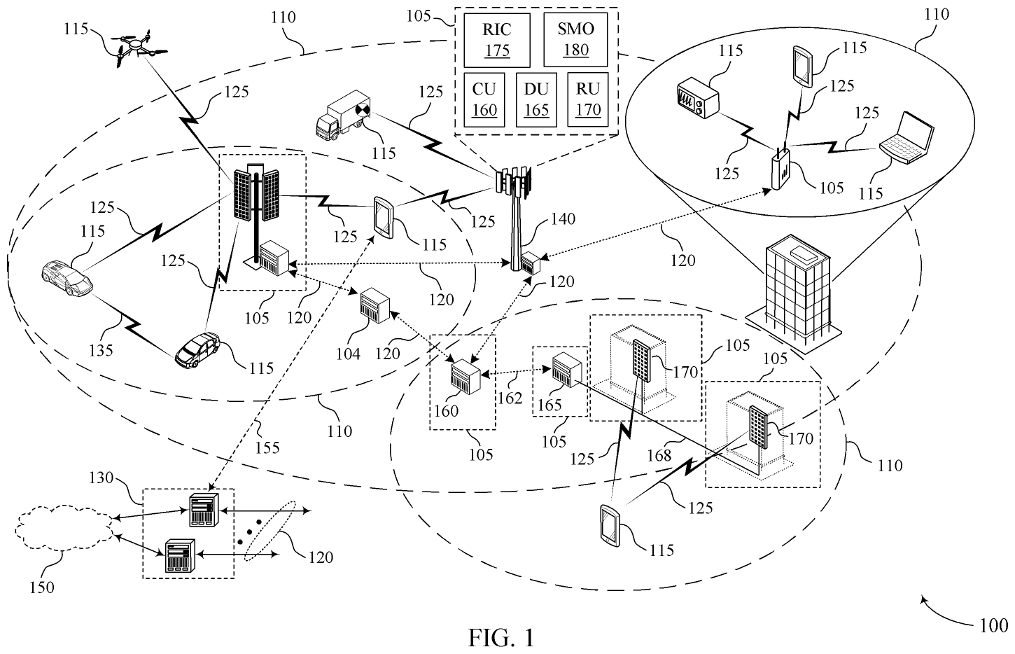

FIG. 1 illustrates an example of a wireless communications system 100 that supports per TRP power control for uplink SFN operation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support per TRP power control for uplink SFN operation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In the wireless communication system 100, a UE 115 may communicate with the network via two or more TRPs. The wireless communications system 100 may apply a unified TCI state framework. In some cases, three types of unified TCI states may be defined. A first type of TCI state (e.g., type 1) may include a joint TCI state to indicate a common beam for at least one downlink channel or reference signal and at least one uplink channel or reference signal (e.g., including UE-specific physical downlink control channel (PDCCH), UE-specific physical downlink shared channel (PDSCH), UE-specific PUCCH, and UE-specific PUSCH). A second type of TCI state (e.g., type 2) may include a downlink TCI state to indicate a common beam for more than one downlink channel or reference signal (e.g., including at least UE-specific PDCCH and UE-specific PDSCH). A third type of TCI state (e.g., type 3) may include an uplink TCI state to indicate a common beam for more than one uplink channel or reference signal (e.g., including at least UE-specific PUCCH and UE-specific PUSCH). For example, the network may indicate to the UE 115 multiple downlink or uplink states for multiple TRPs.

In some cases, the UE 115 may be configured to transmit uplink communications via an SFN configuration. In an SFN configuration, a UE may transmit a same uplink signal to two or more TRPs using different beams via different antenna panels at the UE 115 and using the same set of time and frequency resources. Example applications for an uplink SFN configuration may include customer premises equipment, fixed wireless broadband, or industrial devices. In some cases, to facilitate simultaneous multi-panel uplink transmission for higher uplink throughput and reliability (e.g., focusing on FR2 and multi-TRP), uplink precoding indication for PUSCH may be specified, where no new codebook is introduced for multi-panel simultaneous transmission. In some cases, a total number of layers may be up to four across all panels and a total number of codewords may be up to two across all panels, considering single DCI and multi-DCI based multi-TRP operation. In some cases, to facilitate simultaneous multi-panel uplink transmission for higher uplink throughput and reliability (e.g., focusing on FR2 and multi-TRP), uplink beam indication for PUCCH or PUSCH may be specified, where a unified TCI framework may be assumed considering single DCI and multi-DCI based multi-TRP operation. For the case of multi-DCI based multi-TRP operation, in some examples only PUSCH+PUSCH or PUCCH+PUCCH may be transmitted across two panels in a same component carrier. In some cases, timing advances for uplink multi-DCI for multi-TRP operation may be specified. In some cases, power control for uplink single DCI for multi-TRP operation may be applied.

Some network entities 105 may configure (e.g., RRC configure) power control parameters for each serving cell of a UE 115. In some cases, multiple sets of power control parameters (e.g., Uplink-powerControl) may be configured for each serving cell of the UE 115. For example, each TCI state may include a set of power control parameters. In some examples, the power control parameters may be configured in a serving cell configuration (e.g., ServingCellConfig). For example, the serving cell configuration may include a list of uplink or downlink power control parameters for a corresponding serving cell, where the power control parameters may be configured for a transmission such as a PUSCH, a PUCCH, or a sounding reference signal (SRS). In some cases, if each TCI state does not include a set of uplink power control parameters, the uplink BWP may include one or more sets of uplink power control parameters.

A UE 115 that establishes communications with a network via two or more TRPs using an SFN configuration for uplink transmissions may determine respective uplink transmission power levels for uplink transmissions to each TRP. The UE 115 operating according to the SEN configuration may transmit uplink transmissions to the two or more TRPs in accordance with the determined respective uplink transmission power levels.

In some cases, the UE 115 may receive a DCI message that includes transmit power command fields for each respective TRP, where the multiple transmit power command fields in the DCI message may be configured by higher layer signaling. In some cases, the UE 115 may determine which transmit power command field is associated with which TRP based on the TCI states associated with the TRPs and the order of the transmit power command fields within the DCI message.

In some cases, the UE 115 may determine a set of power control parameters associated with each TRP based on TCI states associated with each TRP. For example, control signaling received at the UE 115 may indicate respective sets of power control parameters associated with each TCI state based on a TCI codepoint, and the UE 115 may determine an uplink transmission power level based for the respective TRPs based on the sets of power control parameters associated with the respective TCI states. Each set of power control parameters may include a path loss reference signal (PLRS) parameter, a nominal power parameters, an alpha value parameter, a closed loop index parameter, a power management maximum power reduction (P-MPR) parameter, or a combination thereof. The control signaling may be higher layer signaling, such as RRC configuration signaling.

In some cases, the UE 115 may transmit power headroom reports for each TRP (e.g., based on measured reference signals received from the TRPs). A power headroom value may indicate how much transmission power is available for the UE 115 to use for an upcoming transmission, calculated as a difference between a maximum available transmission power and a demanded transmission power of for an upcoming transmission based on a set of power control parameters. A real power headroom report may be based on an actual PUSCH to be transmitted (which may also be referred to as an actual uplink transmission, scheduled uplink transmission, scheduled PUSCH, real uplink transmission, or real PUSCH). A virtual power headroom report may be based on a reference PUSCH transmission (which may also be referred to as a reference uplink transmission, virtual uplink transmission, virtual PUSCH, non-schedule uplink transmission, or non-scheduled PUSCH) instead of a real PUSCH transmission, such that the virtual power headroom report is based on some assumption of parameters related to the PUSCH transmission instead of actual indicated parameters for the actual PUSCH transmission. A real power headroom report may also be referred to as a schedule power head room report or actual headroom report. A virtual head room report may also be referred to as a non-scheduled head room report.

The UE 115 may receive an indication of uplink power levels for the TRPs from the network based on the reported power headroom reports. In some cases, at least the second set of power control parameters may be associated with virtual power headroom report(s). The UE 115 may transmit a message including a first power headroom report generated by the UE 115 for a first uplink transmission (e.g., a scheduled or non-scheduled PUSCH transmission) using the first set of power control parameters. In addition, the message may include a second power headroom report generated by the UE for an uplink transmission (e.g., a scheduled or non-scheduled PUSCH transmission) using the second set of power control parameters. Accordingly, the UE 115 may transmit two power headroom reports to the network based on the UE 115 being in communication with two TRPs with separate sets of uplink power control parameters.

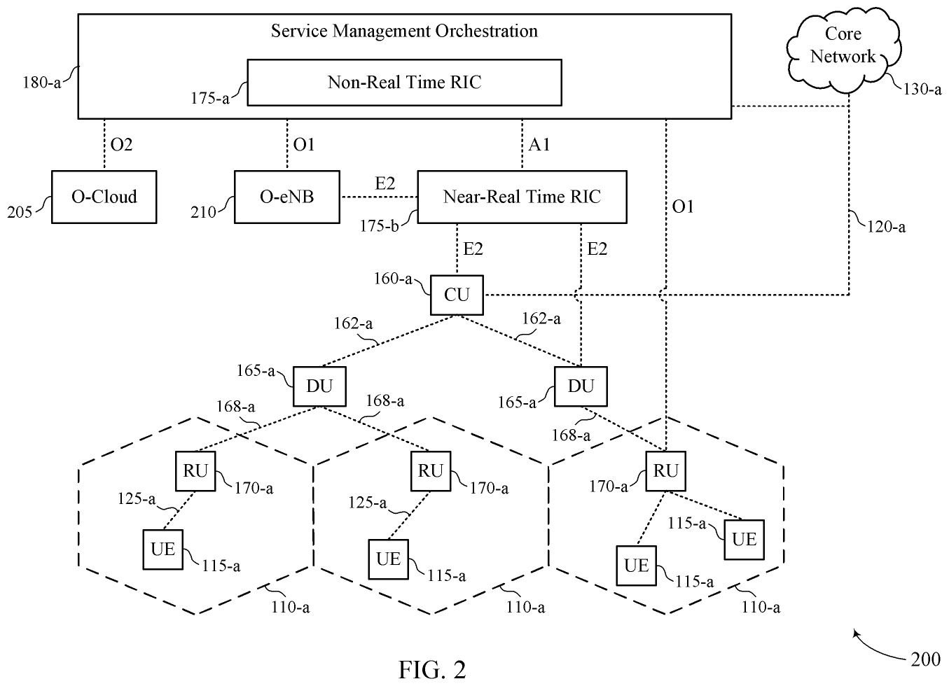

FIG. 2 illustrates an example of a network architecture 200 (e.g., a disaggregated base station architecture, a disaggregated RAN architecture) that supports per transmission and reception point power control for uplink SFN operation in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an AI interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., AI policies).

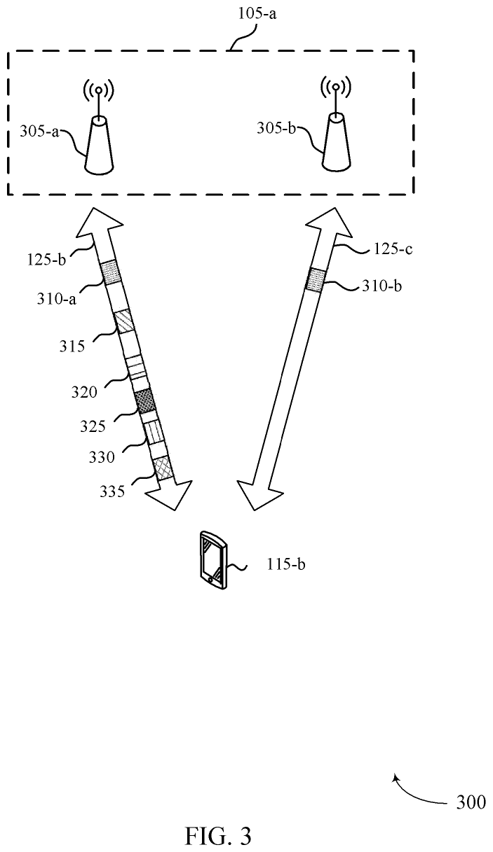

FIG. 3 illustrates an example of a wireless communications system 300 that supports per TRP power control for uplink SFN operation in accordance with one or more aspects of the present disclosure. In some examples, the wireless communications system 300 may implement aspects of wireless communications system 100. The wireless communications system 300 may include a UE 115-b, which may be an example of a UE 115 as described herein. The wireless communications system 300 may include a network entity 105-a, which may be an example of a network entity 105 as described herein.

The UE 115-b may operate in a multiple TRP mode with a first TRP 305-a and a second TRP 305-b. In some cases, the first TRP 305-a and the second TRP 305-b may be located at a same network entity 105-a. In some cases, the first TRP 305-a and the second TRP 305-b may be located at different network entities.

The UE 115-b may be capable of performing simultaneous communication with the first TRP 305-a and the second TRP 305-b (e.g., using a same set of time resources, or a same set of frequency resource, or both, but different spatial resources). The UE 115-b may communicate with the first TRP 305-a using a communication link 125-b. The UE 115-b may communicate with the second TRP 305-b using a communication link 125-c. The communication link 125-b and the communication link 125-c may include bi-directional links that enable both uplink and downlink communication. For example, the UE 115-b may transmit uplink signals, such as uplink control signals or uplink data signals, to the first TRP 305-a using the communication link 125-b and the first TRP 305-a may transmit downlink transmissions, such as downlink control signals or downlink data signals, to the UE 115-b using the communication link 125-b. The UE 115-b may transmit uplink signals, such as uplink control signals or uplink data signals, to the second TRP 305-b using the communication link 125-c and the second TRP 305-b may transmit downlink transmissions, such as downlink control signals or downlink data signals, to the UE 115-b using the communication link 125-c. In some examples, different TRPs (e.g., the first TRP 305-a and the second TRP 305-b) may have different TRP identifiers (IDs). In some examples, different TRPs may be identified through an association with other IDs, such as a CORESET pool index, closed loop index, TCI ID, TCI group ID, or a sounding reference signal resource set ID.

In a single DCI multi-TRP operation or a multi-DCI multi-TRP operation, the UE 115-b may communicate with the first TRP 305-a and the second TRP 305-b using space division multiplexing, frequency division multiplexing, or time division multiplexing, or a combination thereof. The wireless communication system may support DCI repetition (e.g., across CORESETs associated with the first TRP 305-a and the second TRP 305-b), PUSCH and PUCCH repetition, a downlink SFN configuration, or an uplink SFN configuration. For example, in downlink, the UE 115-b may receive PDSCH or PDCCH messages according to an SFN configuration. For example, the UE 115-b may receive a same downlink signal (e.g., a PDSCH or PDCCH message) from the first TRP 305-a and the second TRP 305-b on different beams using different antenna panels at the UE 115-b. In uplink, the UE 115-b may transmit PUSCH or PUCCH messages according to an SFN configuration. For example, the UE 115-b may transmit a same uplink signal to the first TRP 305-a and the second TRP 305-b on different beams using different antenna panels at the UE 115-b.

The UE 115-b may establish a communications link with the network entity 105-b via the first TRP 305-a and the second TRP 305-b according to an SFN configuration. The UE 115-b may determine a first uplink power level for first uplink transmissions 310-a to the first TRP 305-a and a second uplink power level for second uplink transmissions 310-b to the second TRP 305-b. In some cases, the network entity 105-a may indicate UE 115-b with transmit power management signaling (e.g., a DCI message 315 or control signaling 320) to support the UE 115-b determining the first uplink power level and the second uplink power level. The UE 115-b may transmit the first uplink transmissions 310-a to the first TRP 305-a in accordance with the first uplink power level and the second uplink transmissions 310-b to the second TRP 305-b in accordance with the second uplink power level.

In some cases, when the UE 115-b is enabled for SFN operation for one uplink channel (e.g., PUSCH or PUCCH), the UE 115-b may be configured with two transmit power command fields in the corresponding DCI message 315 to indicate the transmit power commands for the SFN uplink transmissions (e.g., first uplink transmissions 310-a and second uplink transmissions 310-b). For example, the SFN uplink transmission (e.g., first uplink transmission 310-a and second uplink transmission 310-b) may be a PUSCH or PUCCH transmission, and the DCI message 315 may schedule the uplink transmission (e.g., first uplink transmission 310-a and second uplink transmission 310-b). For example, a DCI 0_0 or a DCI 0_2 with two transmit power command fields may schedule a PUSCH transmission, or a DCI 1_1 or 1_2 with two transmit power command fields may schedule a PUCCH.

In some cases, a mapping between two transmit power command fields and two uplink applicable TCI states in the TCI codepoint may be determined by the order of the transmit power command fields and the two TCI states associated with the first TRP 305-a and the second TRP 305-b. For example, the first transmit power command field may indicate the transmit power command to the first TCI state in the TCI codepoint, and the second transmit power command field may indicate the transmit power command to the second TCI state in the TCI codepoint. Accordingly, the UE 115-b may map the two transmit power commands in the two transmit power command fields to the first TRP 305-a and the second TRP 305-b. In some cases, a mapping between two transmit power command fields and two uplink applicable TCI states in the TCI codepoint may be determined by the order of the transmit power command fields and two closed loop indexes of two TCI states associated with the first TRP 305-a and the second TRP 305-b. For example, each transmit power command field is for each closed loop index value, the first transmit power command field may indicate the transmit power command to a TCI state of the first closed loop index in the TCI codepoint, and the second transmit power command field may indicate the transmit power command to a TCI state of the second closed loop index in the TCI codepoint. In some cases, the second transmit power command field may be valid when two TCI states are indicated in the TCI codepoint and the two closed loop indexes associated with two TCI states are different. In some cases, where one TCI state is indicated in the TCI codepoint or where the two closed loop indexes associated with two TCI states are not different, the first transmit power command field may be valid and the second transmit power command field may be invalid, and the first transmit power command field may be applied to one or two TCI states.

In some cases, when the UE 115-b is enabled for SFN operation for uplink channel (e.g., PUSCH or PUCCH, both, or additional uplink channels), the UE 115-b may be indicated with two sets of power control parameters for an SFN uplink transmission (e.g., first uplink transmissions 310-a and second uplink transmissions 310-b). For example, the UE 115-b may identify, based on a first TCI state associated with the first TRP 305-a and a second TCI state associated with the second TRP 305-b, a first set of power control parameters associated with the first TRP 305-a and a second set of power control parameters associated with the second TRP 305-b for an SFN uplink transmission (e.g., first uplink transmissions 310-a and second uplink transmissions 310-b). In some cases, two sets of power control parameters may be included in two uplink applicable TCI states in the TCI codepoint. For example, the control signaling 320 (such as RRC signaling, or MAC-CE signaling) may indicate a first set of power control parameters are associated with the first TCI state and the second set of power control parameters are associated with the second TCI state based on the TCI codepoint including the first TCI state and the second TCI state.

In some cases, the control signaling 320 may indicate two sets of power control parameters for each uplink BWP of a set of multiple uplink BWPs. The UE 115-b may identify the first set of power control parameters associated with the first TRP 305-a and the second set of power control parameters associated with the second TRP 305-b based on an uplink BWP of the set of multiple uplink BWPs associated with the first uplink transmission 310-a and the second uplink transmission 310-b. For example, per BWP, the first set of power control parameters may be applied to the first TCI state in the TCI codepoint and the second set of power control parameters may be applied to the second TCI state in the TCI codepoint.

In some cases, the first set of power control parameters may be a first default set of power control parameters and the second set of power control parameters may be a second set of default power control parameters. For example, the UE 115-b may determine to apply the first default set of power control parameters and the second default set of power control parameters based on power control parameters not being included in the TCI states. In some cases, the first set of default power control parameters may be applied to the first TCI state in the TCI codepoint and the second set of default power control parameters may be applied to the second TCI state in the TCI codepoint. For example, the configured parameter Uplink-powerControl of the lowest identifier in the component carrier may be applied to the first TCI state in the TCI codepoint and the configured parameter Uplink-powerControl of the second lowest identifier in the component carrier may be applied to the second TCI state in the TCI codepoint. As another example, the configured parameter Uplink-powerControl of the closed loop index “0” with a lowest identifier in the component carrier may be applied to the a TCI state of close loop index “0” in the TCI codepoint and the configured parameter Uplink-powerControl of the closed loop index “1” with a lowest identifier in the component carrier may be applied to the a TCI state of closed loop index “1” in the TCI codepoint.

In some cases, when the UE 115-b is enabled with SFN operation for a PUSCH, the UE 115-b may be configured to report two power headroom reports for an SFN based PUSCH transmission in a serving cell. For example, the UE 115-b may transmit a message 325 to the network including two power headroom reports associated with the first TRP 305-a and the second TRP 305-b. In some cases, the network may transmit control signaling 330 to the UE 115-b indicating for the UE 115-b to report a first power headroom report associated with the first TRP 305-a and a second power headroom report associated with the second TRP 305-b. In some cases, the UE 115-b may receive the control signaling 320 indicating the first uplink power level for the first uplink transmission 310-a and the second uplink power level for the second uplink transmission 310-b in response to transmitting the message including the two power headroom reports.

In some cases, the UE 115-b may receive control signaling 335 scheduling the uplink transmission (e.g., PUSCH transmission) associated with the two power headroom reports. If the control signaling 335 schedules a non-SFN PUSCH transmission, the UE 115-b may report a real power headroom report and a virtual power headroom report. If the control signaling 335 schedules an SFN PUSCH transmission, the UE 115-b may report two real power headroom reports. If the UE 115-b is configured to report two power headroom reports without a PUSCH transmission being scheduled, the UE 115-b may report two virtual power headroom reports. When calculating a virtual power headroom report, the UE 115-b may assume the power control parameters (which may include PLRS, P-MPR, nominal transmit power, alpha, or closed loop index) are associated with the unified TCI state related to the virtual power headroom report.

In some cases, the UE 115-b may be indicated with two set of beam failure detection resources for beam failure recovery. The UE 115-b UE can be provided by a RRC configuration, for each BWP of a serving cell, a set q0 of periodic CSI-RS resource configuration indexes failureDetectionResourcesToAddModList and a set q1 of periodic CSI-RS resource configuration indexes and/or search space or physical broadcast channel (PBCH) block indexes by candidateBeamRSList or candidate BeamRSListExt or candidateBeamRSSCellList for radio link quality measurements on the BWP of the serving cell. Instead of the sets q0 and q1, for each BWP of a serving cell, the UE 115-b may be provided by an RRC configuration with respective two sets q0,0 and q0,1 of periodic CSI-RS resource configuration indexes by failureDetectionSet1-r17 and failureDetectionSet2-r17 that can be activated by a MAC control element (CE) and corresponding two sets q1,0 and q1, 1 of periodic CSI-RS resource configuration indexes and/or search space or PBCH block indexes by candidateBeamRSList1 and candidateBeamRSList2, respectively, for radio link quality measurements on the BWP of the serving cell. If the number of resources configured in each set q0,0 and q0,1 is equal to or less than a number of supported beam failure detection resources to measure (e.g., a value “NBFD”) indicated by a UE capability, the UE 115-b may consider that the resources in each set q0,0 and q0, 1 are to be measured. The set q0,0 may be associated with the set q1,0 and the set q0, 1 may be associated with the set q1,1. The UE 115-b does not expect that one of set q0,0 and q0, 1 is configured more than a number of supported beam failure detection resources to measure and another set is configured with less than or equal to a number of supported beam failure detection resources to measure. In some aspects, this may be applicable to the UE 115-b configured with any downlink multi-TRP operation (single DCI based, or multiple DCI based multi-TRP operation), and the uplink transmission may be configured with SFN transmission. In some other aspects, this may be applicable to the UE 115-b configured with any downlink multi-TRP operation (single DCI based, or multiple DCI based mTRP operation), and the uplink transmission may not be configured with SFN transmission.

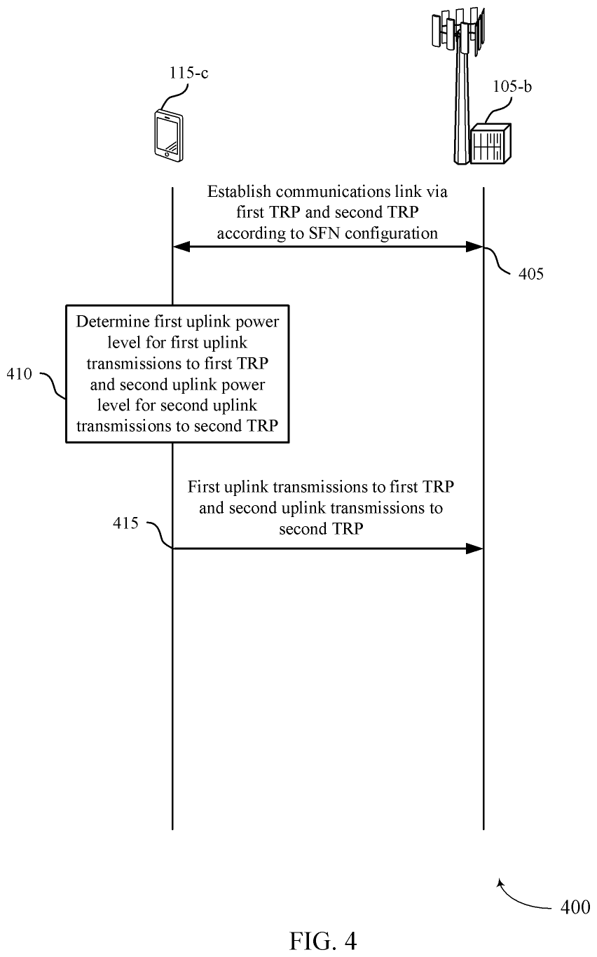

FIG. 4 illustrates an example of a process flow 400 that supports per TRP power control for uplink SFN operation in accordance with one or more aspects of the present disclosure. The process flow 400 may include a UE 115-c, which may be an example of a UE 115 as described herein. The process flow 400 may include a network entity 105-b, which may be an example of a network entity 105 as described herein. In the following description of the process flow 400, the operations between the network entity 105-b and the UE 115-c may be transmitted in a different order than the example order shown, or the operations performed by the network entity 105-b and the UE 115-c may be performed in different orders or at different times. Some operations may also be omitted from the process flow 400, and other operations may be added to the process flow 400.

At 405, the UE 115-c may establish a communications link with the network entity 105-b via a first TRP and a second TRP according to an SFN configuration. Establishing the communications link with the network entity 105-b according to the SFN configuration may include receiving a first set of parameter values for a first set of antenna elements of the UE 115-c for uplink transmissions to the first TRP and a second set of parameter values for a second set of antenna elements of the UE 115-c for uplink transmissions to the second TRP during a same set of time and frequency resources.

At 410, the UE 115-c may determine a first uplink power level for first uplink transmissions to the network entity 105-b via the first TRP and a second uplink power level for second uplink transmissions to the network entity 105-b via the second TRP.

At 415, the UE 115-c may transmit the first uplink transmissions to the first TRP in accordance with the first uplink power level and the second uplink transmissions to the second TRP in accordance with the second uplink power level.

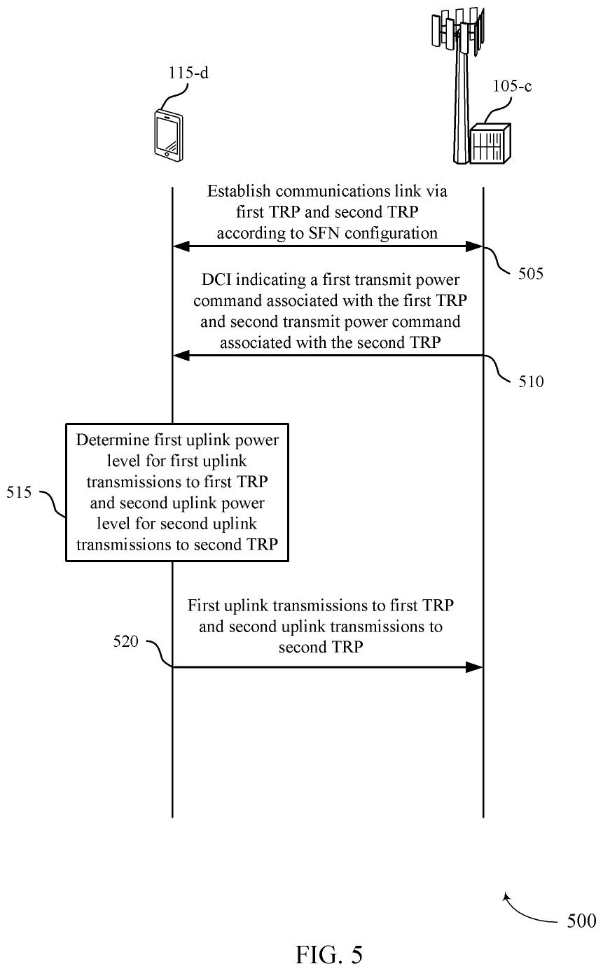

FIG. 5 illustrates an example of a process flow 500 that supports per TRP power control for uplink SFN operation in accordance with one or more aspects of the present disclosure. The process flow 500 may include a UE 115-d, which may be an example of a UE 115 as described herein. The process flow 500 may include a network entity 105-c, which may be an example of a network entity 105 as described herein. In the following description of the process flow 500, the operations between the network entity 105-c and the UE 115-d may be transmitted in a different order than the example order shown, or the operations performed by the network entity 105-c and the UE 115-d may be performed in different orders or at different times. Some operations may also be omitted from the process flow 500, and other operations may be added to the process flow 500.

At 505, the UE 115-d may establish a communications link with the network entity 105-c via a first TRP and a second TRP according to an SFN configuration. Establishing the communications link with the network entity 105-c according to the SFN configuration may include receiving a first set of parameter values for a first set of antenna elements of the UE 115-d for uplink transmissions to the first TRP and a second set of parameter values for a second set of antenna elements of the UE 115-d for uplink transmissions to the second TRP during a same set of time and frequency resources.

At 510, the UE 115-d may receive, from the network entity 105-c, a DCI message indicating a first transmit power command associated with the first TRP and a second transmit power command associated with the second TRP.

At 515, the UE 115-d may determine a first uplink power level for first uplink transmissions to the network entity 105-c via the first TRP and a second uplink power level for second uplink transmissions to the network entity 105-c via the second TRP based on the first transmit power command and the second transmit power command.

In some cases, the UE 115-d may determine that a first field of the DCI message indicating the first transmit power command is associated with a first TCI state of a TCI codepoint and a second field of the DCI message indicating the second transmit power command is associated with a second TCI state of the TCI codepoint based at least in part on an order of the first field and the second field within the DCI message.

In some cases, the UE 115-d may determine that a first field of the DCI message indicating the first transmit power command is associated with a first TCI state of a first closed loop index in a TCI codepoint and a second field of the DCI message indicating the second transmit power command is associated with a second TCI state of a second closed loop index in the TCI codepoint based at least in part on an order of the first field and the second field within the DCI message.

At 520, the UE 115-d may transmit the first uplink transmissions to the first TRP in accordance with the first uplink power level and the second uplink transmissions to the second TRP in accordance with the second uplink power level.

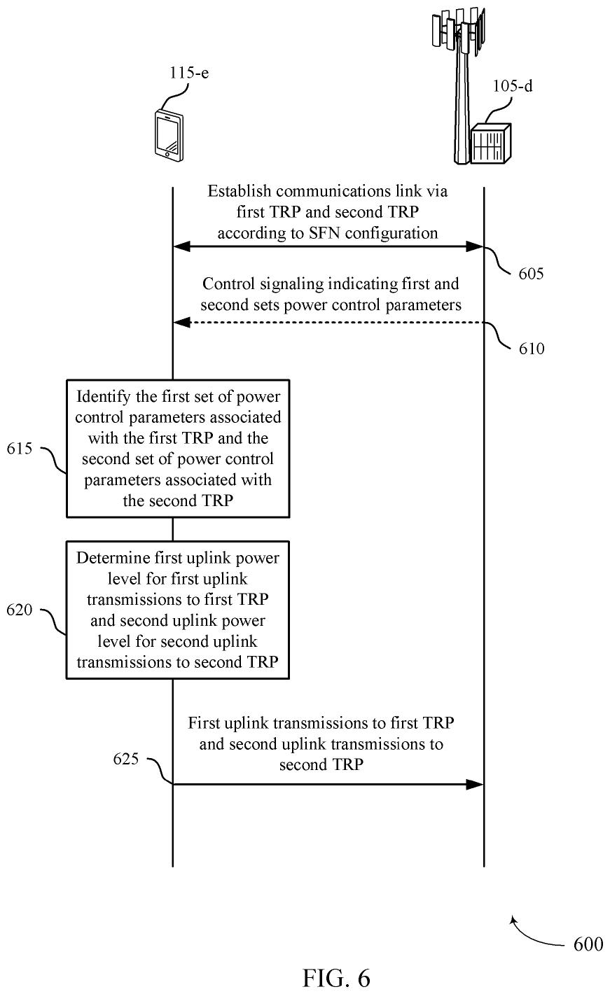

FIG. 6 illustrates an example of a process flow 600 that supports per TRP power control for uplink SFN operation in accordance with one or more aspects of the present disclosure. The process flow 600 may include a UE 115-e, which may be an example of a UE 115 as described herein. The process flow 600 may include a network entity 105-d, which may be an example of a network entity 105 as described herein. In the following description of the process flow 600, the operations between the network entity 105-d and the UE 115-e may be transmitted in a different order than the example order shown, or the operations performed by the network entity 105-d and the UE 115-e may be performed in different orders or at different times. Some operations may also be omitted from the process flow 600, and other operations may be added to the process flow 600.

At 605, the UE 115-e may establish a communications link with the network entity 105-d via a first TRP and a second TRP according to an SFN configuration. Establishing the communications link with the network entity 105-d according to the SFN configuration may include receiving a first set of parameter values for a first set of antenna elements of the UE 115-e for uplink transmissions to the first TRP and a second set of parameter values for a second set of antenna elements of the UE 115-e for uplink transmissions to the second TRP during a same set of time and frequency resources.

At 615, the UE 115-e may identify, based on a first TCI state associated with the first TRP and a second TCI state associated with the second TRP, a first set of power control parameters associated with the first TRP and a second set of power control parameters associated with the second TRP.

In some cases, at 610, the UE 115-e may receive, from the network entity 105-d, control signaling indicating the first set of power control parameters and the second set of power control parameters. In some examples, the control signaling may indicate the first set of power control parameters are associated with the first TCI state and the second set of power control parameters are associated with the second TCI state based on a TCI codepoint including the first TCI state and the second TCI state.

In some cases, the control signaling may indicate two sets of power control parameters for each uplink BWP of a set of multiple uplink BWPs. The UE 115-e may identify the first set of power control parameters associated with the first TRP and the second set of power control parameters associated with the second TRP based on an uplink BWP of the set of multiple uplink BWPs associated with the first uplink transmissions and the second uplink transmissions.

In some cases, the first set of power control parameters may be a first default set of power control parameters and the second set of power control parameters may be a second set of default power control parameters. For example, the UE 115-e may determine to apply the first default set of power control parameters and the second default set of power control parameters based on not receiving control signaling indicating first and second sets of power control parameters.

At 620, the UE 115-e may determine a first uplink power level for first uplink transmissions to the network entity 105-d via the first TRP and a second uplink power level for second uplink transmissions to the network entity 105-d via the second TRP based on the first set of power control parameters and the second set of power control parameters identified at 515.

At 625, the UE 115-e may transmit the first uplink transmissions to the first TRP in accordance with the first uplink power level and the second uplink transmissions to the second TRP in accordance with the second uplink power level.

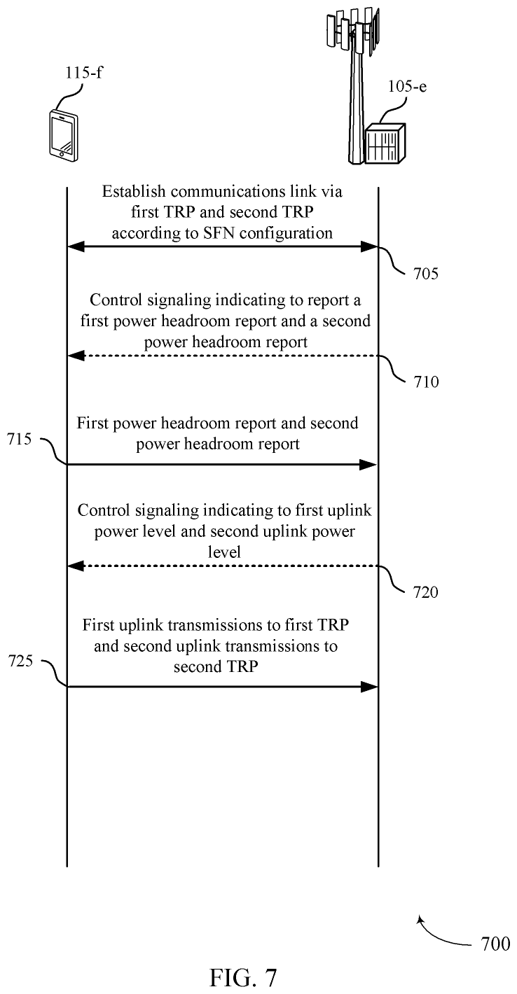

FIG. 7 illustrates an example of a process flow 700 that supports per TRP power control for uplink SFN operation in accordance with one or more aspects of the present disclosure. The process flow 700 may include a UE 115-f, which may be an example of a UE 115 as described herein. The process flow 700 may include a network entity 105-e, which may be an example of a network entity 105 as described herein. In the following description of the process flow 700, the operations between the network entity 105-e and the UE 115-f may be transmitted in a different order than the example order shown, or the operations performed by the network entity 105-e and the UE 115-f may be performed in different orders or at different times. Some operations may also be omitted from the process flow 700, and other operations may be added to the process flow 700.

At 705, the UE 115-f may establish a communications link with the network entity 105-d via a first TRP and a second TRP according to an SFN configuration. Establishing the communications link with the network entity 105-e according to the SFN configuration may include receiving a first set of parameter values for a first set of antenna elements of the UE 115-f for uplink transmissions to the first TRP and a second set of parameter values for a second set of antenna elements of the UE 115-f for uplink transmissions to the second TRP during a same set of time and frequency resources.

In some cases, at 710, the UE 115-f may receive, from the network entity 105-e, control signaling indicating for the UE 115-f to report a first power headroom report associated with the first TRP and a second power headroom report associated with the second TRP.

At 715, the UE 115-f may transmit, to the network entity 105-e, a message including a first power headroom report associated with the first TRP and a second power headroom report associated with the second TRP. In some cases, the UE 115-f may receive control signaling scheduling an uplink transmission using the SFN configuration, and the first power headroom report and the second power headroom report may be real power headroom reports associated with the uplink transmission. In some cases, the UE 115-f may receive control signaling scheduling an uplink transmission using a transmission configuration different from the SFN configuration, and the first power headroom report may be a real power headroom report associated with the uplink transmission and the second power headroom report may be a virtual power headroom report. In some cases, the UE 115-f may not receive scheduling information for an uplink transmission associated with the first or second TRPs, and the first power headroom report and the second power headroom report may be virtual power headroom reports.

In some cases, at 720, the UE 115-f may receive, from the network entity 105-e, control signaling indicating a first uplink power level for first uplink transmissions to the network entity 105-e via the first TRP and a second uplink power level for second uplink transmissions to the network entity 105-e via the first TRP. In some cases, the first uplink power level and the second uplink power level may be based on the first power headroom report and the second power headroom report.

At 725, the UE 115-f may transmit the first uplink transmissions to the first TRP in accordance with the first uplink power level and the second uplink transmissions to the second TRP in accordance with the second uplink power level.

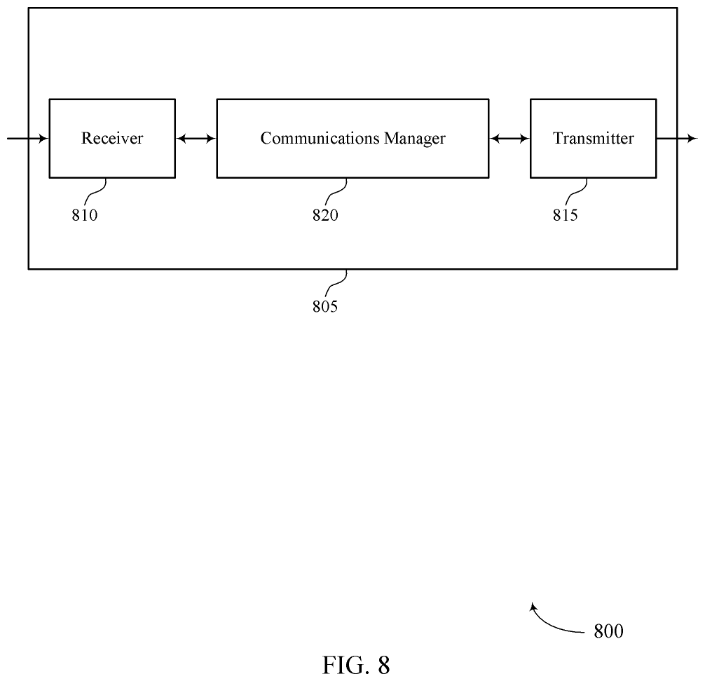

FIG. 8 shows a block diagram 800 of a device 805 that supports per TRP power control for uplink SFN operation in accordance with one or more aspects of the present disclosure. The device 805 may be an example of aspects of a UE 115 as described herein. The device 805 may include a receiver 810, a transmitter 815, and a communications manager 820. The device 805 may also include one or more processors, memory coupled with the one or more processors, and instructions stored in the memory that are executable by the one or more processors to enable the one or more processors to perform the [broad title feature] features discussed herein. Each of these components may be in communication with one another (e.g., via one or more buses).

The receiver 810 may provide a means for receiving information such as packets, user data, control information, or any combination thereof associated with various information channels (e.g., control channels, data channels, information channels related to per TRP power control for uplink SFN operation). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to per TRP power control for uplink SFN operation). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of per TRP power control for uplink SFN operation as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. For example, the communications manager 820 may be configured as or otherwise support a means for establishing a communications link with a network via a first TRP and a second TRP according to an SFN configuration. The communications manager 820 may be configured as or otherwise support a means for determining a first uplink power level for first uplink transmissions to the network via the first TRP and a second uplink power level for second uplink transmissions to the network via the second TRP. The communications manager 820 may be configured as or otherwise support a means for transmitting the first uplink transmissions to the first TRP in accordance with the first uplink power level and the second uplink transmissions to the second TRP in accordance with the second uplink power level.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for more efficient utilization of communication resources by configuring per-TRP power control for SFN uplink transmissions.

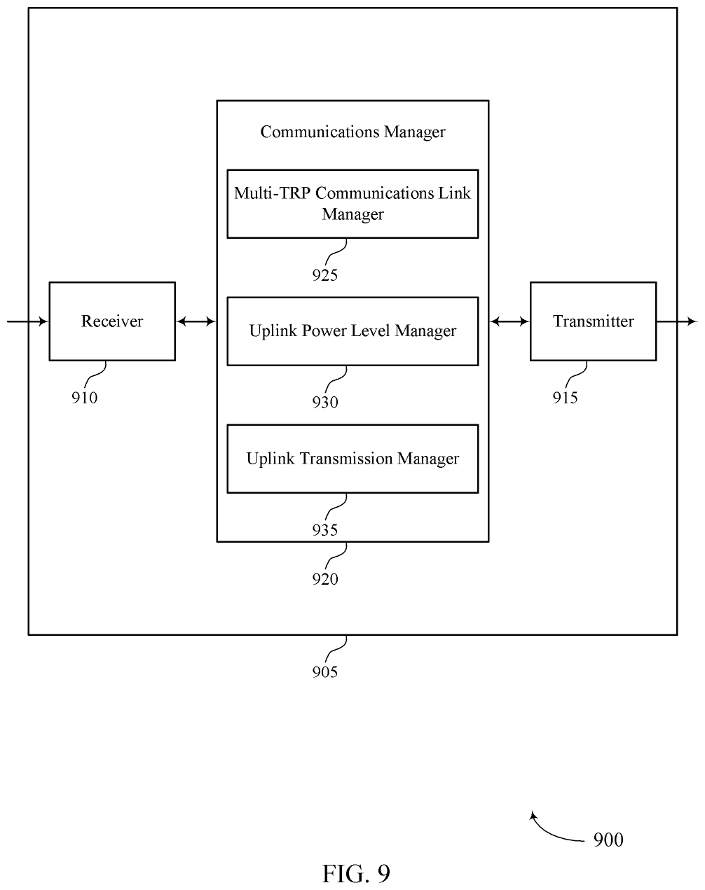

FIG. 9 shows a block diagram 900 of a device 905 that supports per TRP power control for uplink SFN operation in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to per TRP power control for uplink SFN operation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to per TRP power control for uplink SFN operation). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of per TRP power control for uplink SFN operation as described herein. For example, the communications manager 920 may include a multi-TRP communications link manager 925, an uplink power level manager 930, an uplink transmission manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. The multi-TRP communications link manager 925 may be configured as or otherwise support a means for establishing a communications link with a network via a first TRP and a second TRP according to an SFN configuration. The uplink power level manager 930 may be configured as or otherwise support a means for determining a first uplink power level for first uplink transmissions to the network via the first TRP and a second uplink power level for second uplink transmissions to the network via the second TRP. The uplink transmission manager 935 may be configured as or otherwise support a means for transmitting the first uplink transmissions to the first TRP in accordance with the first uplink power level and the second uplink transmissions to the second TRP in accordance with the second uplink power level.

In some cases, the multi-TRP communications link manager 925, the uplink power level manager 930, and the uplink transmission manager 935 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the multi-TRP communications link manager 925, the uplink power level manager 930, and the uplink transmission manager 935 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

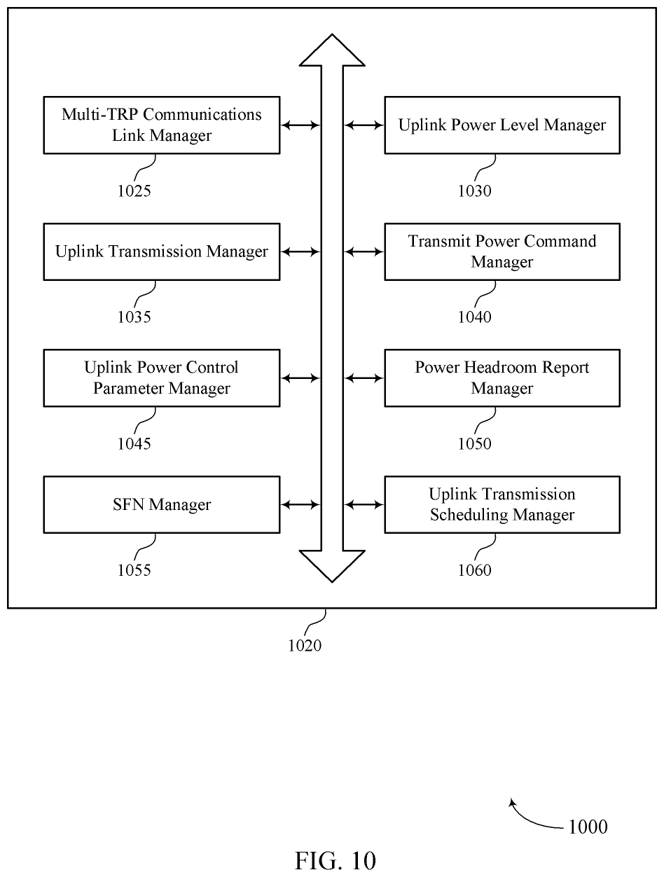

FIG. 10 shows a block diagram 1000 of a communications manager 1020 that supports per TRP power control for uplink SFN operation in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of per TRP power control for uplink SFN operation as described herein. For example, the communications manager 1020 may include a multi-TRP communications link manager 1025, an uplink power level manager 1030, an uplink transmission manager 1035, a transmit power command manager 1040, an uplink power control parameter manager 1045, a power headroom report manager 1050, an SFN manager 1055, an uplink transmission scheduling manager 1060, or any combination thereof. Each of these components may communicate, directly or indirectly, with one another (e.g., via one or more buses).

The communications manager 1020 may support wireless communications at a UE in accordance with examples as disclosed herein. The multi-TRP communications link manager 1025 may be configured as or otherwise support a means for establishing a communications link with a network via a first TRP and a second TRP according to an SFN configuration. The uplink power level manager 1030 may be configured as or otherwise support a means for determining a first uplink power level for first uplink transmissions to the network via the first TRP and a second uplink power level for second uplink transmissions to the network via the second TRP. The uplink transmission manager 1035 may be configured as or otherwise support a means for transmitting the first uplink transmissions to the first TRP in accordance with the first uplink power level and the second uplink transmissions to the second TRP in accordance with the second uplink power level.

In some examples, the transmit power command manager 1040 may be configured as or otherwise support a means for receiving a DCI message indicating a first transmit power command associated with the first TRP and a second transmit power command associated with the second TRP, where determining the first uplink power level and the second uplink power level is based on the first transmit power command and the second transmit power command.

In some examples, the transmit power command manager 1040 may be configured as or otherwise support a means for determining that a first field indicating the first transmit power command is associated with a first TCI state of a TCI codepoint and a second field indicating the second transmit power command is associated with a second TCI state of the TCI codepoint based on an order of the first field and the second field within the DCI message.

In some examples, the transmit power command manager 1040 may be configured as or otherwise support a means for determining that a first field indicating the first transmit power command is associated with a first TCI state of a first closed loop index in a TCI codepoint and a second field indicating the second transmit power command is associated with a second TCI state of a second closed loop index in the TCI codepoint based on an order of the first field and the second field within the DCI message.

In some examples, the uplink power control parameter manager 1045 may be configured as or otherwise support a means for identifying, based on a first TCI state associated with the first TRP and a second TCI state associated with the second TRP, a first set of power control parameters associated with the first TRP and a second set of power control parameters associated with the second TRP, where determining the first uplink power level for the first uplink transmissions and the second uplink power level for the second uplink transmissions is based on the first set of power control parameters and the second set of power control parameters.

In some examples, the uplink power control parameter manager 1045 may be configured as or otherwise support a means for receiving control signaling indicating the first set of power control parameters are associated with the first TCI state and the second set of power control parameters are associated with the second TCI state based on a TCI codepoint including the first TCI state and the second TCI state.

In some examples, the uplink power control parameter manager 1045 may be configured as or otherwise support a means for receiving control signaling indicating two sets of power control parameters for each uplink BWP of a set of multiple uplink BWPs, where the identifying is based on an uplink BWP of the set of multiple uplink BWPs associated with the first uplink transmissions and the second uplink transmissions.

In some examples, the first set of power control parameters includes a first default set of power control parameters and the second set of power control parameters includes a second set of default power control parameters.

In some examples, the power headroom report manager 1050 may be configured as or otherwise support a means for transmitting a message including a first power headroom report associated with the first TRP and a second power headroom report associated with the second TRP.

In some examples, the power headroom report manager 1050 may be configured as or otherwise support a means for receiving control signaling indicating for the UE to report the first power headroom report and the second power headroom report.

In some examples, the uplink transmission scheduling manager 1060 may be configured as or otherwise support a means for receiving control signaling scheduling an uplink transmission using the SFN configuration, where the first power headroom report and the second power headroom report include real power headroom reports associated with the uplink transmission.

In some examples, the uplink transmission scheduling manager 1060 may be configured as or otherwise support a means for receiving control signaling scheduling an uplink transmission using a transmission configuration different from the SFN configuration, where the first power headroom report includes a real power headroom report associated with the uplink transmission and the second power headroom report includes a virtual power headroom report.

In some examples, to support establishing the communications link with the network according to the SFN configuration, the SFN manager 1055 may be configured as or otherwise support a means for receiving a first set of parameter values for a first set of antenna elements of the UE for uplink transmissions to the first TRP and a second set of parameter values for a second set of antenna elements of the UE for uplink transmissions to the second TRP during a same set of time and frequency resources.

In some cases, the multi-TRP communications link manager 1025, the uplink power level manager 1030, the uplink transmission manager 1035, the transmit power command manager 1040, the uplink power control parameter manager 1045, the power headroom report manager 1050, the SFN manager 1055, and the uplink transmission scheduling manager 1060 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the multi-TRP communications link manager 1025, the uplink power level manager 1030, the uplink transmission manager 1035, the transmit power command manager 1040, the uplink power control parameter manager 1045, the power headroom report manager 1050, the SFN manager 1055, and the uplink transmission scheduling manager 1060 discussed herein.

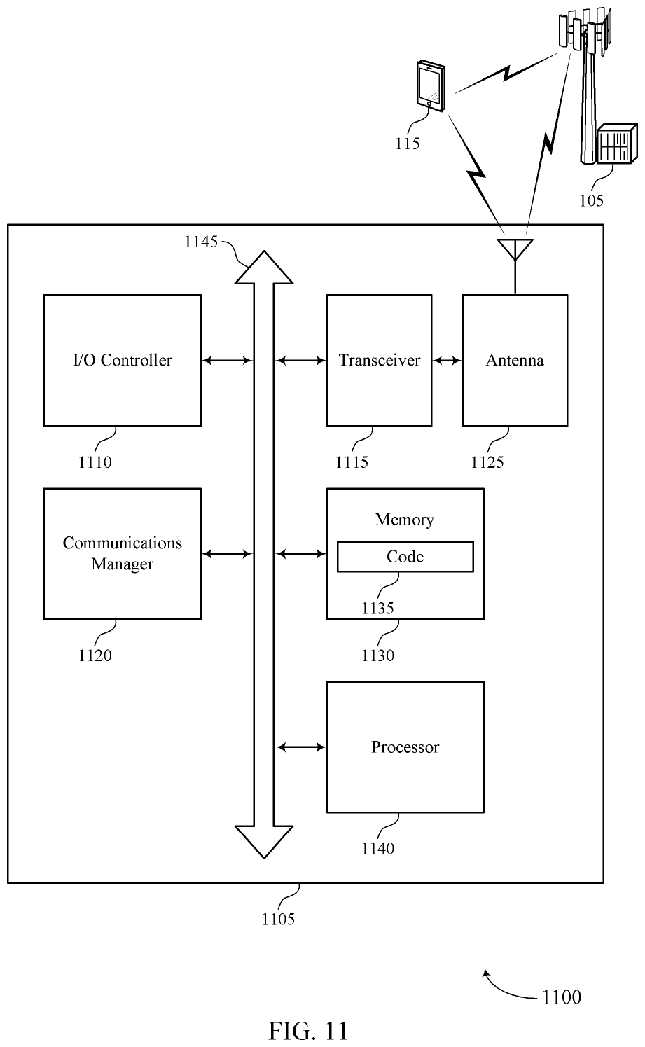

FIG. 11 shows a diagram of a system 1100 including a device 1105 that supports per TRP power control for uplink SFN operation in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting per TRP power control for uplink SFN operation). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communications at a UE in accordance with examples as disclosed herein. For example, the communications manager 1120 may be configured as or otherwise support a means for establishing a communications link with a network via a first TRP and a second TRP according to an SFN configuration. The communications manager 1120 may be configured as or otherwise support a means for determining a first uplink power level for first uplink transmissions to the network via the first TRP and a second uplink power level for second uplink transmissions to the network via the second TRP. The communications manager 1120 may be configured as or otherwise support a means for transmitting the first uplink transmissions to the first TRP in accordance with the first uplink power level and the second uplink transmissions to the second TRP in accordance with the second uplink power level.

By including or configuring the communications manager 1120 in accordance with examples as described herein, the device 1105 may support techniques for more efficient utilization of communication resources and improved coordination between devices by configuring per-TRP power control for SFN uplink transmissions.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of per TRP power control for uplink SFN operation as described herein, or the processor 1140 and the memory 1130 may be otherwise configured to perform or support such operations.

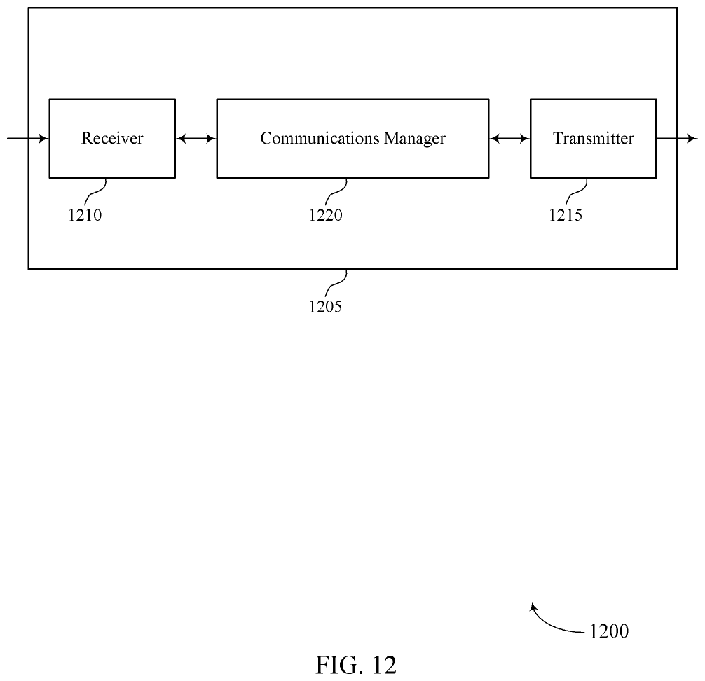

FIG. 12 shows a block diagram 1200 of a device 1205 that supports per TRP power control for uplink SFN operation in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include one or more processors, memory coupled with the one or more processors, and instructions stored in the memory that are executable by the one or more processors to enable the one or more processors to perform the [broad title feature] features discussed herein. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of per TRP power control for uplink SFN operation as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. For example, the communications manager 1220 may be configured as or otherwise support a means for establishing a communications link with a UE via a first TRP and a second TRP according to an SFN configuration. The communications manager 1220 may be configured as or otherwise support a means for transmitting, to the UE, power management signaling configured to support the UE determining a first uplink power level for first uplink transmissions to the first TRP and a second uplink power level for second uplink transmissions to the second TRP. The communications manager 1220 may be configured as or otherwise support a means for receiving, from the UE at least in part in response to the transmitted power management signaling, the first uplink transmissions via the first TRP in accordance with the first uplink power level and the second uplink transmissions via the second TRP in accordance with the second uplink power level.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for more efficient utilization of communication resources by configuring per-TRP power control for SFN uplink transmissions.

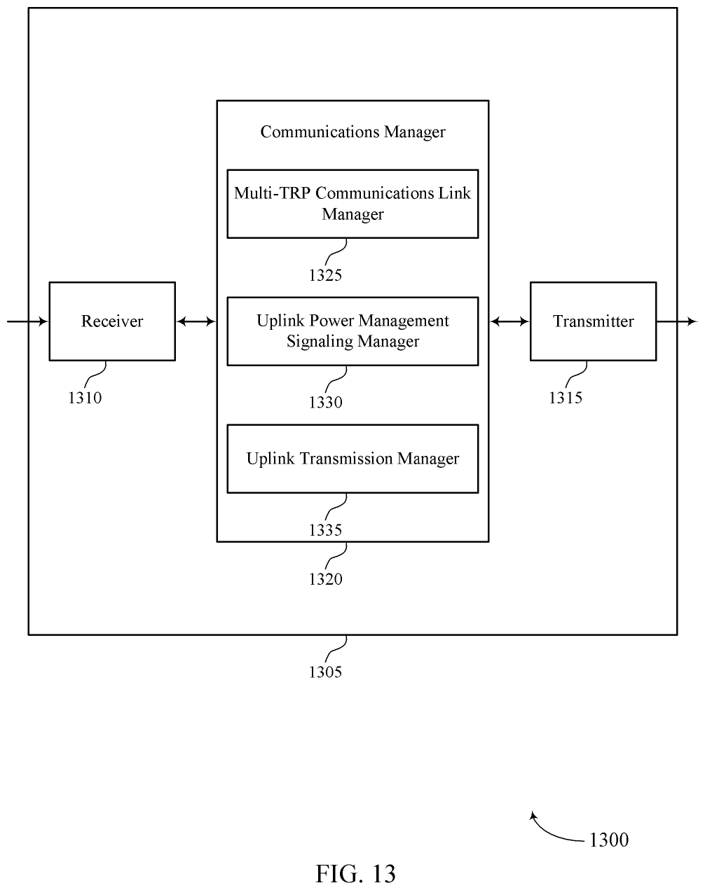

FIG. 13 shows a block diagram 1300 of a device 1305 that supports per TRP power control for uplink SFN operation in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of per TRP power control for uplink SFN operation as described herein. For example, the communications manager 1320 may include a multi-TRP communications link manager 1325, an uplink power management signaling manager 1330, an uplink transmission manager 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a network entity in accordance with examples as disclosed herein. The multi-TRP communications link manager 1325 may be configured as or otherwise support a means for establishing a communications link with a UE via a first TRP and a second TRP according to an SFN configuration. The uplink power management signaling manager 1330 may be configured as or otherwise support a means for transmitting, to the UE, power management signaling configured to support the UE determining a first uplink power level for first uplink transmissions to the first TRP and a second uplink power level for second uplink transmissions to the second TRP. The uplink transmission manager 1335 may be configured as or otherwise support a means for receiving, from the UE at least in part in response to the transmitted power management signaling, the first uplink transmissions via the first TRP in accordance with the first uplink power level and the second uplink transmissions via the second TRP in accordance with the second uplink power level.

In some cases, the multi-TRP communications link manager 1325, the uplink power management signaling manager 1330, and the uplink transmission manager 1335 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the multi-TRP communications link manager 1325, the uplink power management signaling manager 1330, and the uplink transmission manager 1335 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

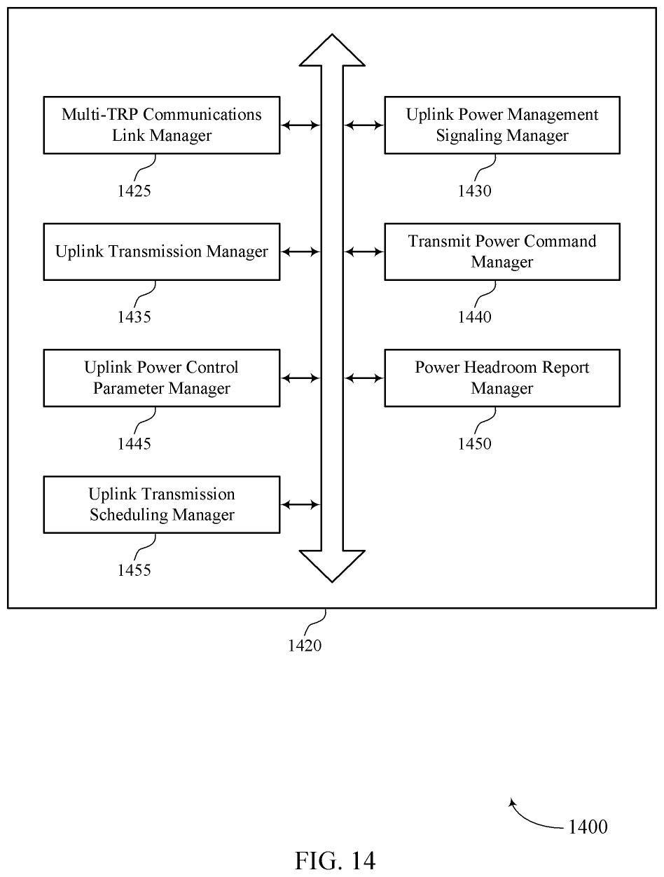

FIG. 14 shows a block diagram 1400 of a communications manager 1420 that supports per TRP power control for uplink SFN operation in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of per TRP power control for uplink SFN operation as described herein. For example, the communications manager 1420 may include a multi-TRP communications link manager 1425, an uplink power management signaling manager 1430, an uplink transmission manager 1435, a transmit power command manager 1440, an uplink power control parameter manager 1445, a power headroom report manager 1450, an uplink transmission scheduling manager 1455, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications at a network entity in accordance with examples as disclosed herein. The multi-TRP communications link manager 1425 may be configured as or otherwise support a means for establishing a communications link with a UE via a first TRP and a second TRP according to an SFN configuration. The uplink power management signaling manager 1430 may be configured as or otherwise support a means for transmitting, to the UE, power management signaling configured to support the UE determining a first uplink power level for first uplink transmissions to the first TRP and a second uplink power level for second uplink transmissions to the second TRP. The uplink transmission manager 1435 may be configured as or otherwise support a means for receiving, from the UE at least in part in response to the transmitted power management signaling, the first uplink transmissions via the first TRP in accordance with the first uplink power level and the second uplink transmissions via the second TRP in accordance with the second uplink power level.

In some examples, to support transmitting the power management signaling, the transmit power command manager 1440 may be configured as or otherwise support a means for transmitting a DCI message indicating a first transmit power command associated with the first TRP and a second transmit power command associated with the second TRP.

In some examples, to support transmitting the DCI message, the transmit power command manager 1440 may be configured as or otherwise support a means for transmitting the DCI message including a first field indicating the first transmit power command is associated with a first TCI state of a TCI codepoint and a second field indicating the second transmit power command is associated with a second TCI state of the TCI codepoint, where the first TRP is associated with the first TCI state and the second TRP is associated with the second TCI state based on an order of the first field and the second field within the DCI message.

In some examples, to support transmitting the DCI message, the transmit power command manager 1440 may be configured as or otherwise support a means for transmitting the DCI message including a first field indicating the first transmit power command is associated with a first TCI state of a first closed loop index in a TCI codepoint and a second field indicating the second transmit power command is associated with a second TCI state of a second closed loop index in the TCI codepoint, where the first TRP is associated with the first TCI state and the second TRP is associated with the second TCI state based on an order of the first field and the second field within the DCI message.

In some examples, to support transmitting the power management signaling, the uplink power control parameter manager 1445 may be configured as or otherwise support a means for transmitting control signaling indicating that a first set of power control parameters are associated with a first TCI state and a second set of power control parameters are associated with a second TCI state based on a TCI codepoint including the first TCI state and the second TCI state, where the first TCI state is associated with the first TRP and the second TCI state is associated with the second TRP.

In some examples, to support transmitting the power management signaling, the uplink power control parameter manager 1445 may be configured as or otherwise support a means for transmitting control signaling indicating two sets of power control parameters for each uplink BWP of a set of multiple uplink BWPs, where an uplink BWP of the set of multiple uplink BWPs is associated with the first uplink transmissions and the second uplink transmissions.

In some examples, the power headroom report manager 1450 may be configured as or otherwise support a means for receiving, from the UE, a message including a first power headroom report associated with the first TRP and a second power headroom report associated with the second TRP.

In some examples, to support transmitting the power management signaling, the uplink transmission manager 1435 may be configured as or otherwise support a means for transmitting control signaling indicating the first uplink power level and the second uplink power level.

In some examples, the power headroom report manager 1450 may be configured as or otherwise support a means for transmitting, to the UE, control signaling indicating for the UE to report the first power headroom report and the second power headroom report.

In some examples, the uplink transmission scheduling manager 1455 may be configured as or otherwise support a means for transmitting, to the UE, control signaling scheduling an uplink transmission using the SFN configuration, where the first power headroom report and the second power headroom report include real power headroom reports associated with the uplink transmission.

In some examples, the uplink transmission scheduling manager 1455 may be configured as or otherwise support a means for transmitting, to the UE, control signaling scheduling an uplink transmission using a transmission configuration different from the SFN configuration, where the first power headroom report includes a real power headroom report associated with the uplink transmission and the second power headroom report includes a virtual power headroom report.

In some cases, the multi-TRP communications link manager 1425, the uplink power management signaling manager 1430, the uplink transmission manager 1435, the transmit power command manager 1440, the uplink power control parameter manager 1445, the power headroom report manager 1450, and the uplink transmission scheduling manager 1455 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the multi-TRP communications link manager 1425, the uplink power management signaling manager 1430, the uplink transmission manager 1435, the transmit power command manager 1440, the uplink power control parameter manager 1445, the power headroom report manager 1450, and the uplink transmission scheduling manager 1455 discussed herein.

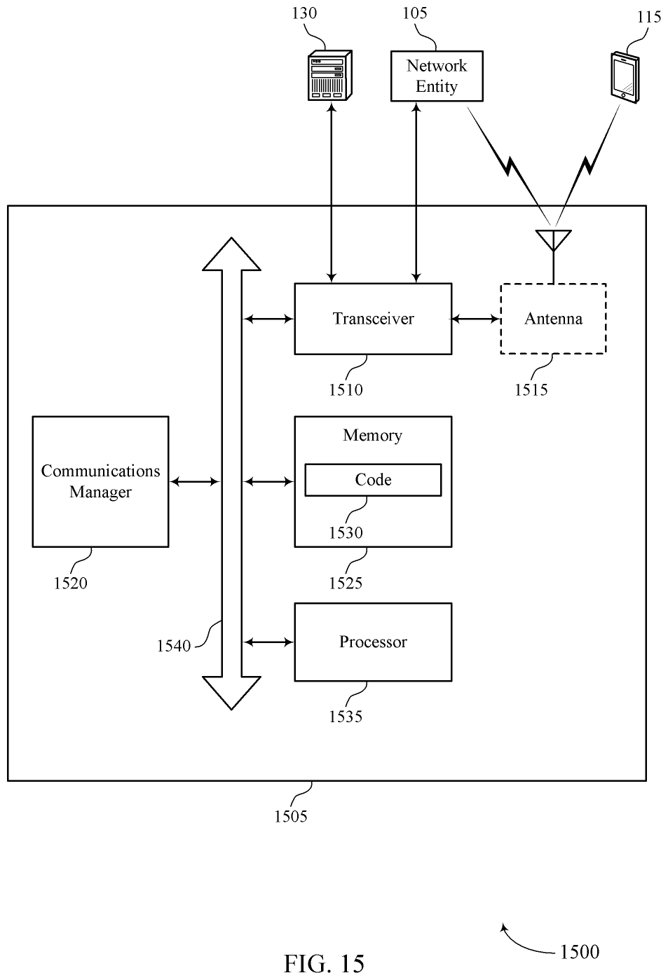

FIG. 15 shows a diagram of a system 1500 including a device 1505 that supports per TRP power control for uplink SFN operation in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. The transceiver 1510, or the transceiver 1510 and one or more antennas 1515 or wired interfaces, where applicable, may be an example of a transmitter 1215, a transmitter 1315, a receiver 1210, a receiver 1310, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting per TRP power control for uplink SFN operation). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communications at a network entity in accordance with examples as disclosed herein. For example, the communications manager 1520 may be configured as or otherwise support a means for establishing a communications link with a UE via a first TRP and a second TRP according to an SFN configuration. The communications manager 1520 may be configured as or otherwise support a means for transmitting, to the UE, power management signaling configured to support the UE determining a first uplink power level for first uplink transmissions to the first TRP and a second uplink power level for second uplink transmissions to the second TRP. The communications manager 1520 may be configured as or otherwise support a means for receiving, from the UE at least in part in response to the transmitted power management signaling, the first uplink transmissions via the first TRP in accordance with the first uplink power level and the second uplink transmissions via the second TRP in accordance with the second uplink power level.

By including or configuring the communications manager 1520 in accordance with examples as described herein, the device 1505 may support techniques for more efficient utilization of communication resources and improved coordination between devices by configuring per-TRP power control for SFN uplink transmissions.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the processor 1535, the memory 1525, the code 1530, the transceiver 1510, or any combination thereof. For example, the code 1530 may include instructions executable by the processor 1535 to cause the device 1505 to perform various aspects of per TRP power control for uplink SFN operation as described herein, or the processor 1535 and the memory 1525 may be otherwise configured to perform or support such operations.

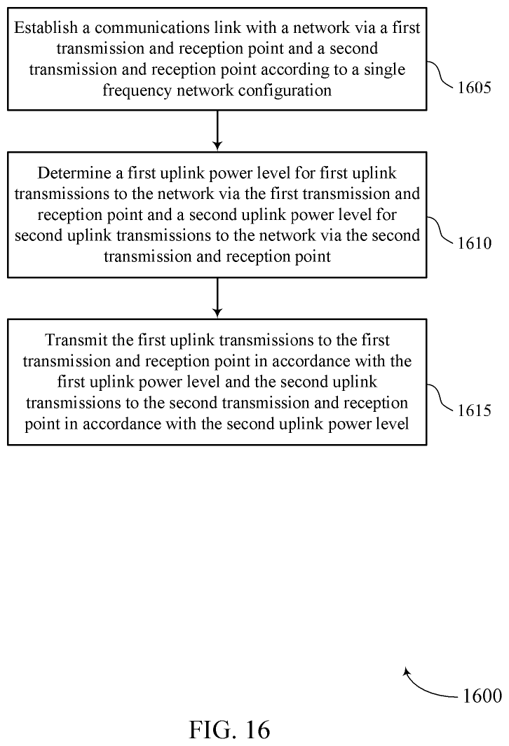

FIG. 16 shows a flowchart illustrating a method 1600 that supports per TRP power control for uplink SFN operation in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include establishing a communications link with a network via a first TRP and a second TRP according to an SFN configuration. The operations of 1605 may be performed in accordance with examples as disclosed herein. In some examples, aspects of the operations of 1605 may be performed by a multi-TRP communications link manager 1025 as described with reference to FIG. 10.

At 1610, the method may include determining a first uplink power level for first uplink transmissions to the network via the first TRP and a second uplink power level for second uplink transmissions to the network via the second TRP. The operations of 1610 may be performed in accordance with examples as disclosed herein. In some examples, aspects of the operations of 1610 may be performed by an uplink power level manager 1030 as described with reference to FIG. 10.

At 1615, the method may include transmitting the first uplink transmissions to the first TRP in accordance with the first uplink power level and the second uplink transmissions to the second TRP in accordance with the second uplink power level. The operations of 1615 may be performed in accordance with examples as disclosed herein. In some examples, aspects of the operations of 1615 may be performed by an uplink transmission manager 1035 as described with reference to FIG. 10.

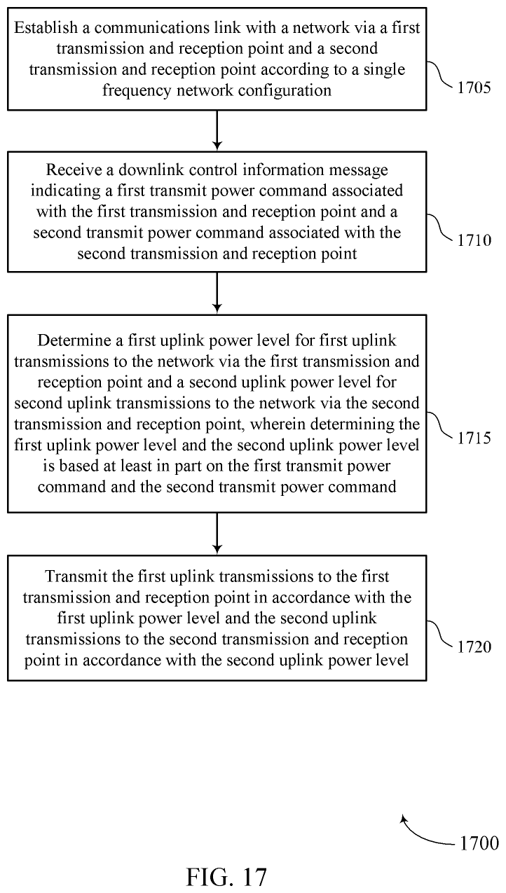

FIG. 17 shows a flowchart illustrating a method 1700 that supports per TRP power control for uplink SFN operation in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include establishing a communications link with a network via a first TRP and a second TRP according to an SFN configuration. The operations of 1705 may be performed in accordance with examples as disclosed herein. In some examples, aspects of the operations of 1705 may be performed by a multi-TRP communications link manager 1025 as described with reference to FIG. 10.

At 1710, the method may include receiving a DCI message indicating a first transmit power command associated with the first TRP and a second transmit power command associated with the second TRP. The operations of 1710 may be performed in accordance with examples as disclosed herein. In some examples, aspects of the operations of 1710 may be performed by a transmit power command manager 1040 as described with reference to FIG. 10.

At 1715, the method may include determining a first uplink power level for first uplink transmissions to the network via the first TRP and a second uplink power level for second uplink transmissions to the network via the second TRP, where determining the first uplink power level and the second uplink power level is based on the first transmit power command and the second transmit power command. The operations of 1715 may be performed in accordance with examples as disclosed herein. In some examples, aspects of the operations of 1715 may be performed by an uplink power level manager 1030 as described with reference to FIG. 10.

At 1720, the method may include transmitting the first uplink transmissions to the first TRP in accordance with the first uplink power level and the second uplink transmissions to the second TRP in accordance with the second uplink power level. The operations of 1720 may be performed in accordance with examples as disclosed herein. In some examples, aspects of the operations of 1720 may be performed by an uplink transmission manager 1035 as described with reference to FIG. 10.

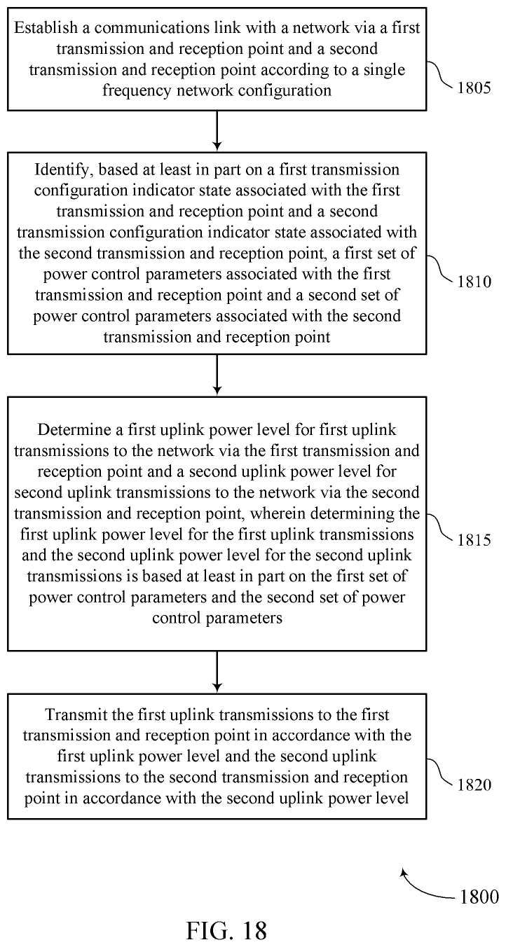

FIG. 18 shows a flowchart illustrating a method 1800 that supports per TRP power control for uplink SFN operation in accordance with one or more aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1805, the method may include establishing a communications link with a network via a first TRP and a second TRP according to an SFN configuration. The operations of 1805 may be performed in accordance with examples as disclosed herein. In some examples, aspects of the operations of 1805 may be performed by a multi-TRP communications link manager 1025 as described with reference to FIG. 10.

At 1810, the method may include identifying, based on a first TCI state associated with the first TRP and a second TCI state associated with the second TRP, a first set of power control parameters associated with the first TRP and a second set of power control parameters associated with the second TRP. The operations of 1810 may be performed in accordance with examples as disclosed herein. In some examples, aspects of the operations of 1810 may be performed by an uplink power control parameter manager 1045 as described with reference to FIG. 10.

At 1815, the method may include determining a first uplink power level for first uplink transmissions to the network via the first TRP and a second uplink power level for second uplink transmissions to the network via the second TRP, where determining the first uplink power level for the first uplink transmissions and the second uplink power level for the second uplink transmissions is based on the first set of power control parameters and the second set of power control parameters. The operations of 1815 may be performed in accordance with examples as disclosed herein. In some examples, aspects of the operations of 1815 may be performed by an uplink power level manager 1030 as described with reference to FIG. 10.

At 1820, the method may include transmitting the first uplink transmissions to the first TRP in accordance with the first uplink power level and the second uplink transmissions to the second TRP in accordance with the second uplink power level. The operations of 1820 may be performed in accordance with examples as disclosed herein. In some examples, aspects of the operations of 1820 may be performed by an uplink transmission manager 1035 as described with reference to FIG. 10.

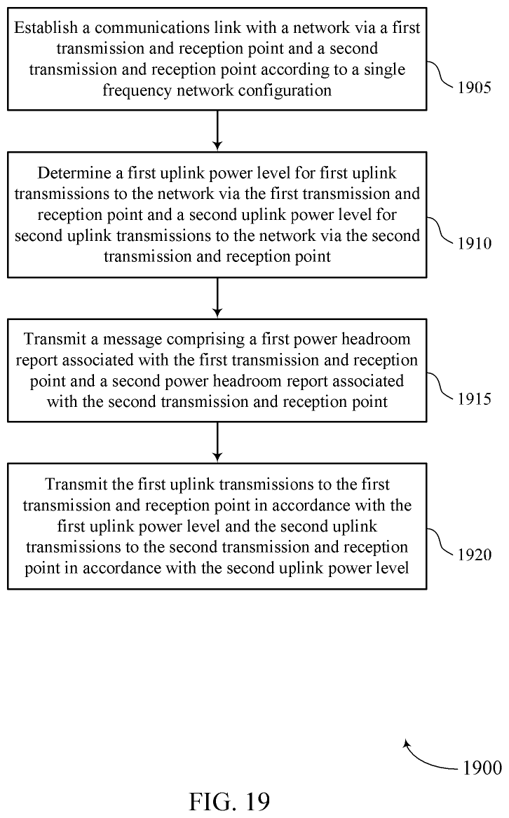

FIG. 19 shows a flowchart illustrating a method 1900 that supports per TRP power control for uplink SFN operation in accordance with one or more aspects of the present disclosure. The operations of the method 1900 may be implemented by a UE or its components as described herein. For example, the operations of the method 1900 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1905, the method may include establishing a communications link with a network via a first TRP and a second TRP according to an SFN configuration. The operations of 1905 may be performed in accordance with examples as disclosed herein. In some examples, aspects of the operations of 1905 may be performed by a multi-TRP communications link manager 1025 as described with reference to FIG. 10.

At 1910, the method may include determining a first uplink power level for first uplink transmissions to the network via the first TRP and a second uplink power level for second uplink transmissions to the network via the second TRP. The operations of 1910 may be performed in accordance with examples as disclosed herein. In some examples, aspects of the operations of 1910 may be performed by an uplink power level manager 1030 as described with reference to FIG. 10.

At 1915, the method may include transmitting a message including a first power headroom report associated with the first TRP and a second power headroom report associated with the second TRP. The operations of 1915 may be performed in accordance with examples as disclosed herein. In some examples, aspects of the operations of 1915 may be performed by a power headroom report manager 1050 as described with reference to FIG. 10.

At 1920, the method may include transmitting the first uplink transmissions to the first TRP in accordance with the first uplink power level and the second uplink transmissions to the second TRP in accordance with the second uplink power level. The operations of 1920 may be performed in accordance with examples as disclosed herein. In some examples, aspects of the operations of 1920 may be performed by an uplink transmission manager 1035 as described with reference to FIG. 10.

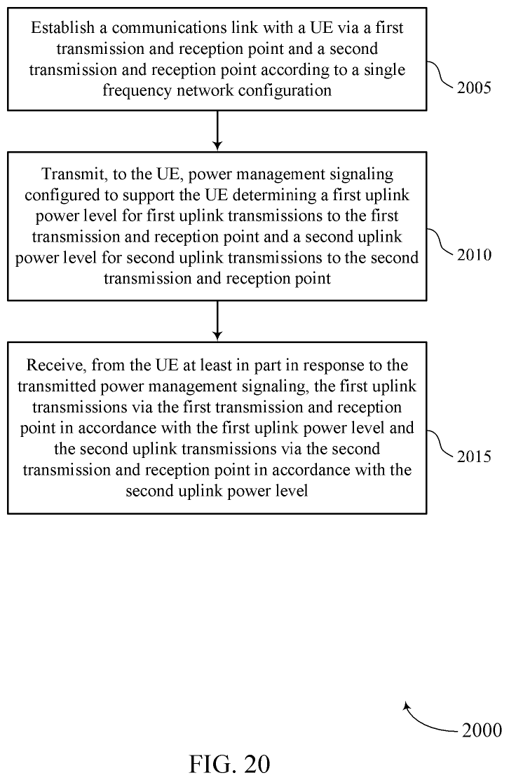

FIG. 20 shows a flowchart illustrating a method 2000 that supports per TRP power control for uplink SFN operation in accordance with one or more aspects of the present disclosure. The operations of the method 2000 may be implemented by a network entity or its components as described herein. For example, the operations of the method 2000 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2005, the method may include establishing a communications link with a UE via a first TRP and a second TRP according to an SFN configuration. The operations of 2005 may be performed in accordance with examples as disclosed herein. In some examples, aspects of the operations of 2005 may be performed by a multi-TRP communications link manager 1425 as described with reference to FIG. 14.

At 2010, the method may include transmitting, to the UE, power management signaling configured to support the UE determining a first uplink power level for first uplink transmissions to the first TRP and a second uplink power level for second uplink transmissions to the second TRP. The operations of 2010 may be performed in accordance with examples as disclosed herein. In some examples, aspects of the operations of 2010 may be performed by an uplink power management signaling manager 1430 as described with reference to FIG. 14.

At 2015, the method may include receiving, from the UE at least in part in response to the transmitted power management signaling, the first uplink transmissions via the first TRP in accordance with the first uplink power level and the second uplink transmissions via the second TRP in accordance with the second uplink power level. The operations of 2015 may be performed in accordance with examples as disclosed herein. In some examples, aspects of the operations of 2015 may be performed by an uplink transmission manager 1435 as described with reference to FIG. 14.

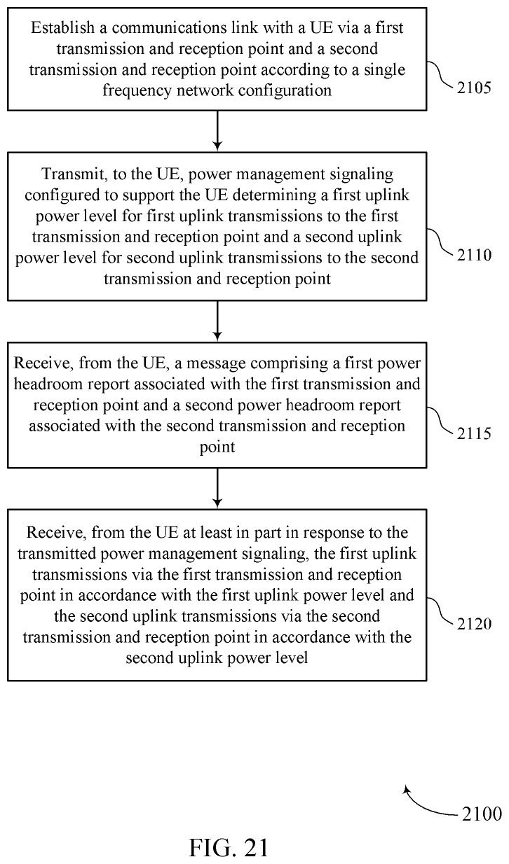

FIG. 21 shows a flowchart illustrating a method 2100 that supports per TRP power control for uplink SFN operation in accordance with one or more aspects of the present disclosure. The operations of the method 2100 may be implemented by a network entity or its components as described herein. For example, the operations of the method 2100 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2105, the method may include establishing a communications link with a UE via a first TRP and a second TRP according to an SFN configuration. The operations of 2105 may be performed in accordance with examples as disclosed herein. In some examples, aspects of the operations of 2105 may be performed by a multi-TRP communications link manager 1425 as described with reference to FIG. 14.

At 2110, the method may include transmitting, to the UE, power management signaling configured to support the UE determining a first uplink power level for first uplink transmissions to the first TRP and a second uplink power level for second uplink transmissions to the second TRP. The operations of 2110 may be performed in accordance with examples as disclosed herein. In some examples, aspects of the operations of 2110 may be performed by an uplink power management signaling manager 1430 as described with reference to FIG. 14.

At 2115, the method may include receiving, from the UE, a message including a first power headroom report associated with the first TRP and a second power headroom report associated with the second TRP. The operations of 2115 may be performed in accordance with examples as disclosed herein. In some examples, aspects of the operations of 2115 may be performed by a power headroom report manager 1450 as described with reference to FIG. 14.

At 2120, the method may include receiving, from the UE at least in part in response to the transmitted power management signaling, the first uplink transmissions via the first TRP in accordance with the first uplink power level and the second uplink transmissions via the second TRP in accordance with the second uplink power level. The operations of 2120 may be performed in accordance with examples as disclosed herein. In some examples, aspects of the operations of 2120 may be performed by an uplink transmission manager 1435 as described with reference to FIG. 14.

The following provides an overview of aspects of the present disclosure:
Aspect 1: A method for wireless communications at a UE, comprising: establishing a communications link with a network via a first TRP and a second TRP according to a SFN configuration; determining a first uplink power level for first uplink transmissions to the network via the first TRP and a second uplink power level for second uplink transmissions to the network via the second TRP; and transmitting the first uplink transmissions to the first TRP in accordance with the first uplink power level and the second uplink transmissions to the second TRP in accordance with the second uplink power level.
Aspect 2: The method of aspect 1, further comprising: receiving a DCI message indicating a first transmit power command associated with the first TRP and a second transmit power command associated with the second TRP, wherein determining the first uplink power level and the second uplink power level is based at least in part on the first transmit power command and the second transmit power command.
Aspect 3: The method of aspect 2, further comprising: determining that a first field indicating the first transmit power command is associated with a first TCI state of a TCI codepoint and a second field indicating the second transmit power command is associated with a second TCI state of the TCI codepoint based at least in part on an order of the first field and the second field within the DCI message.
Aspect 4: The method of any of aspects 2 through 3, further comprising: determining that a first field indicating the first transmit power command is associated with a first TCI state of a first closed loop index in a TCI codepoint and a second field indicating the second transmit power command is associated with a second TCI state of a second closed loop index in the TCI codepoint based at least in part on an order of the first field and the second field within the DCI message.
Aspect 5: The method of any of aspects 1 through 4, further comprising: identifying, based at least in part on a first TCI state associated with the first TRP and a second TCI state associated with the second TRP, a first set of power control parameters associated with the first TRP and a second set of power control parameters associated with the second TRP, wherein determining the first uplink power level for the first uplink transmissions and the second uplink power level for the second uplink transmissions is based at least in part on the first set of power control parameters and the second set of power control parameters.
Aspect 6: The method of aspect 5, further comprising: receiving control signaling indicating the first set of power control parameters are associated with the first TCI state and the second set of power control parameters are associated with the second TCI state based at least in part on a TCI codepoint comprising the first TCI state and the second TCI state.
Aspect 7: The method of any of aspects 5 through 6, further comprising: receiving control signaling indicating two sets of power control parameters for each uplink bandwidth part of a plurality of uplink bandwidth parts, wherein the identifying is based at least in part on an uplink bandwidth part of the plurality of uplink bandwidth parts associated with the first uplink transmissions and the second uplink transmissions.
Aspect 8: The method of any of aspects 5 through 7, wherein the first set of power control parameters comprises a first default set of power control parameters and the second set of power control parameters comprises a second set of default power control parameters.
Aspect 9: The method of any of aspects 1 through 8, further comprising: transmitting a message comprising a first power headroom report associated with the first TRP and a second power headroom report associated with the second TRP.
Aspect 10: The method of aspect 9, further comprising: receiving control signaling indicating for the UE to report the first power headroom report and the second power headroom report.
Aspect 11: The method of any of aspects 9 through 10, further comprising: receiving control signaling scheduling an uplink transmission using the SFN configuration, wherein the first power headroom report and the second power headroom report comprise real power headroom reports associated with the uplink transmission.
Aspect 12: The method of any of aspects 9 through 11, further comprising: receiving control signaling scheduling an uplink transmission using a transmission configuration different from the SFN configuration, wherein the first power headroom report comprises a real power headroom report associated with the uplink transmission and the second power headroom report comprises a virtual power headroom report.
Aspect 13: The method of any of aspects 1 through 12, wherein establishing the communications link with the network according to the SFN configuration comprises: receiving a first set of parameter values for a first set of antenna elements of the UE for uplink transmissions to the first TRP and a second set of parameter values for a second set of antenna elements of the UE for uplink transmissions to the second TRP during a same set of time and frequency resources.
Aspect 14: A method for wireless communications at a network entity, comprising: establishing a communications link with a UE via a first TRP and a second TRP according to a SFN configuration; transmitting, to the UE, power management signaling configured to support the UE determining a first uplink power level for first uplink transmissions to the first TRP and a second uplink power level for second uplink transmissions to the second TRP; and receiving, from the UE at least in part in response to the transmitted power management signaling, the first uplink transmissions via the first TRP in accordance with the first uplink power level and the second uplink transmissions via the second TRP in accordance with the second uplink power level.
Aspect 15: The method of aspect 14, wherein transmitting the power management signaling comprises: transmitting a DCI message indicating a first transmit power command associated with the first TRP and a second transmit power command associated with the second TRP.
Aspect 16: The method of aspect 15, wherein transmitting the DCI message comprises: transmitting the DCI message comprising a first field indicating the first transmit power command is associated with a first TCI state of a TCI codepoint and a second field indicating the second transmit power command is associated with a second TCI state of the TCI codepoint, wherein the first TRP is associated with the first TCI state and the second TRP is associated with the second TCI state based at least in part on an order of the first field and the second field within the DCI message.
Aspect 17: The method of any of aspects 15 through 16, wherein transmitting the DCI message comprises: transmitting the DCI message comprising a first field indicating the first transmit power command is associated with a first TCI state of a first closed loop index in a TCI codepoint and a second field indicating the second transmit power command is associated with a second TCI state of a second closed loop index in the TCI codepoint, wherein the first TRP is associated with the first TCI state and the second TRP is associated with the second TCI state based at least in part on an order of the first field and the second field within the DCI message.
Aspect 18: The method of any of aspects 14 through 17, wherein transmitting the power management signaling comprises: transmitting control signaling indicating that a first set of power control parameters are associated with a first TCI state and a second set of power control parameters are associated with a second TCI state based at least in part on a TCI codepoint comprising the first TCI state and the second TCI state, wherein the first TCI state is associated with the first TRP and the second TCI state is associated with the second TRP.
Aspect 19: The method of any of aspects 14 through 18, wherein transmitting the power management signaling comprises: transmitting control signaling indicating two sets of power control parameters for each uplink bandwidth part of a plurality of uplink bandwidth parts, wherein an uplink bandwidth part of the plurality of uplink bandwidth parts is associated with the first uplink transmissions and the second uplink transmissions.
Aspect 20: The method of any of aspects 14 through 19, further comprising: receiving, from the UE, a message comprising a first power headroom report associated with the first TRP and a second power headroom report associated with the second TRP.
Aspect 21: The method of aspect 20, wherein transmitting the power management signaling comprises: transmitting control signaling indicating the first uplink power level and the second uplink power level.
Aspect 22: The method of any of aspects 20 through 21, further comprising: transmitting, to the UE, control signaling indicating for the UE to report the first power headroom report and the second power headroom report.
Aspect 23: The method of any of aspects 20 through 22, further comprising: transmitting, to the UE, control signaling scheduling an uplink transmission using the SFN configuration, wherein the first power headroom report and the second power headroom report comprise real power headroom reports associated with the uplink transmission.
Aspect 24: The method of any of aspects 20 through 23, further comprising: transmitting, to the UE, control signaling scheduling an uplink transmission using a transmission configuration different from the SFN configuration, wherein the first power headroom report comprises a real power headroom report associated with the uplink transmission and the second power headroom report comprises a virtual power headroom report.
Aspect 25: An apparatus for wireless communications at a UE, comprising a processor; memory coupled with the processor; and instructions stored in the memory and executable by the processor to cause the apparatus to perform a method of any of aspects 1 through 13.
Aspect 26: An apparatus for wireless communications at a UE, comprising at least one means for performing a method of any of aspects 1 through 13.
Aspect 27: A non-transitory computer-readable medium storing code for wireless communications at a UE, the code comprising instructions executable by a processor to perform a method of any of aspects 1 through 13.
Aspect 28: An apparatus for wireless communications at a network entity, comprising a processor; memory coupled with the processor; and instructions stored in the memory and executable by the processor to cause the apparatus to perform a method of any of aspects 14 through 24.
Aspect 29: An apparatus for wireless communications at a network entity, comprising at least one means for performing a method of any of aspects 14 through 24.
Aspect 30: A non-transitory computer-readable medium storing code for wireless communications at a network entity, the code comprising instructions executable by a processor to perform a method of any of aspects 14 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
establish a communications link with a network via a first transmission and reception point and a second transmission and reception point according to a SFN configuration;
determine a first uplink power level for first uplink transmissions to the network via the first transmission and reception point and a second uplink power level for second uplink transmissions to the network via the second transmission and reception point; and
transmit the first uplink transmissions to the first transmission and reception point in accordance with the first uplink power level and the second uplink transmissions to the second transmission and reception point in accordance with the second uplink power level.

2. The apparatus of claim 1, wherein the instructions are further executable by the processor to cause the apparatus to:
receive a DCI message indicating a first transmit power command associated with the first transmission and reception point and a second transmit power command associated with the second transmission and reception point, wherein determining the first uplink power level and the second uplink power level is based at least in part on the first transmit power command and the second transmit power command.

3. The apparatus of claim 2, wherein the instructions are further executable by the processor to cause the apparatus to:
determine that a first field indicating the first transmit power command is associated with a first transmission configuration indicator state of a transmission configuration indicator codepoint and a second field indicating the second transmit power command is associated with a second transmission configuration indicator state of the transmission configuration indicator codepoint based at least in part on an order of the first field and the second field within the DCI message.

4. The apparatus of claim 2, wherein the instructions are further executable by the processor to cause the apparatus to:
determine that a first field indicating the first transmit power command is associated with a first transmission configuration indicator state of a first closed loop index in a transmission configuration indicator codepoint and a second field indicating the second transmit power command is associated with a second transmission configuration indicator state of a second closed loop index in the transmission configuration indicator codepoint based at least in part on an order of the first field and the second field within the DCI message.

5. The apparatus of claim 1, wherein the instructions are further executable by the processor to cause the apparatus to:
identify, based at least in part on a first transmission configuration indicator state associated with the first transmission and reception point and a second transmission configuration indicator state associated with the second transmission and reception point, a first set of power control parameters associated with the first transmission and reception point and a second set of power control parameters associated with the second transmission and reception point, wherein determining the first uplink power level for the first uplink transmissions and the second uplink power level for the second uplink transmissions is based at least in part on the first set of power control parameters and the second set of power control parameters.

6. The apparatus of claim 5, wherein the instructions are further executable by the processor to cause the apparatus to:
receive control signaling indicating the first set of power control parameters are associated with the first transmission configuration indicator state and the second set of power control parameters are associated with the second transmission configuration indicator state based at least in part on a transmission configuration indicator codepoint comprising the first transmission configuration indicator state and the second transmission configuration indicator state.

7. The apparatus of claim 5, wherein the instructions are further executable by the processor to cause the apparatus to:
receive control signaling indicating two sets of power control parameters for each uplink bandwidth part of a plurality of uplink bandwidth parts, wherein the identifying is based at least in part on an uplink bandwidth part of the plurality of uplink bandwidth parts associated with the first uplink transmissions and the second uplink transmissions.

8. The apparatus of claim 5, wherein the first set of power control parameters comprises a first default set of power control parameters and the second set of power control parameters comprises a second set of default power control parameters.

9. The apparatus of claim 1, wherein the instructions are further executable by the processor to cause the apparatus to:
transmit a message comprising a first power headroom report associated with the first transmission and reception point and a second power headroom report associated with the second transmission and reception point.

10. The apparatus of claim 9, wherein the instructions are further executable by the processor to cause the apparatus to:
receive control signaling indicating for the UE to report the first power headroom report and the second power headroom report.

11. The apparatus of claim 9, wherein the instructions are further executable by the processor to cause the apparatus to:
receive control signaling scheduling an uplink transmission using the SFN configuration, wherein the first power headroom report and the second power headroom report comprise real power headroom reports associated with the uplink transmission.

12. The apparatus of claim 9, wherein the instructions are further executable by the processor to cause the apparatus to:
receive control signaling scheduling an uplink transmission using a transmission configuration different from the SFN configuration, wherein the first power headroom report comprises a real power headroom report associated with the uplink transmission and the second power headroom report comprises a virtual power headroom report.

13. The apparatus of claim 1, wherein the instructions are further executable by the processor to establish the communications link with the network according to the SFN configuration by being executable by the processor to:
receive a first set of parameter values for a first set of antenna elements of the UE for uplink transmissions to the first transmission and reception point and a second set of parameter values for a second set of antenna elements of the UE for uplink transmissions to the second transmission and reception point during a same set of time and frequency resources.

14. An apparatus for wireless communications at a network entity, comprising:
a processor;
memory coupled with the processor; and
instructions stored in the memory and executable by the processor to cause the apparatus to:
establish a communications link with a user equipment (UE) via a first transmission and reception point and a second transmission and reception point according to a SFN configuration;
transmit, to the UE, power management signaling configured to support the UE determining a first uplink power level for first uplink transmissions to the first transmission and reception point and a second uplink power level for second uplink transmissions to the second transmission and reception point; and
receive, from the UE at least in part in response to the transmitted power management signaling, the first uplink transmissions via the first transmission and reception point in accordance with the first uplink power level and the second uplink transmissions via the second transmission and reception point in accordance with the second uplink power level.

15. The apparatus of claim 14, wherein the instructions are further executable by the processor to transmit the power management signaling by being executable by the processor to:
transmit a DCI message indicating a first transmit power command associated with the first transmission and reception point and a second transmit power command associated with the second transmission and reception point.

16. The apparatus of claim 15, wherein the instructions are further executable by the processor to transmit the DCI message by being executable by the processor to:
transmit the DCI message comprising a first field indicating the first transmit power command is associated with a first transmission configuration indicator state of a transmission configuration indicator codepoint and a second field indicating the second transmit power command is associated with a second transmission configuration indicator state of the transmission configuration indicator codepoint, wherein the first transmission and reception point is associated with the first transmission configuration indicator state and the second transmission and reception point is associated with the second transmission configuration indicator state based at least in part on an order of the first field and the second field within the DCI message.

17. The apparatus of claim 15, wherein the instructions are further executable by the processor to transmit the DCI message by being executable by the processor to:
transmit the DCI message comprising a first field indicating the first transmit power command is associated with a first transmission configuration indicator state of a first closed loop index in a transmission configuration indicator codepoint and a second field indicating the second transmit power command is associated with a second transmission configuration indicator state of a second closed loop index in the transmission configuration indicator codepoint, wherein the first transmission and reception point is associated with the first transmission configuration indicator state and the second transmission and reception point is associated with the second transmission configuration indicator state based at least in part on an order of the first field and the second field within the DCI message.

18. The apparatus of claim 14, wherein the instructions are further executable by the processor to transmit the power management signaling by being executable by the processor to:
transmit control signaling indicating that a first set of power control parameters are associated with a first transmission configuration indicator state and a second set of power control parameters are associated with a second transmission configuration indicator state based at least in part on a transmission configuration indicator codepoint comprising the first transmission configuration indicator state and the second transmission configuration indicator state, wherein the first transmission configuration indicator state is associated with the first transmission and reception point and the second transmission configuration indicator state is associated with the second transmission and reception point.

19. The apparatus of claim 14, wherein the instructions are further executable by the processor to transmit the power management signaling by being executable to:
transmit control signaling indicating two sets of power control parameters for each uplink bandwidth part of a plurality of uplink bandwidth parts, wherein an uplink bandwidth part of the plurality of uplink bandwidth parts is associated with the first uplink transmissions and the second uplink transmissions.

20. The apparatus of claim 14, wherein the instructions are further executable by the processor to cause the apparatus to:
receive, from the UE, a message comprising a first power headroom report associated with the first transmission and reception point and a second power headroom report associated with the second transmission and reception point.

21. The apparatus of claim 20, wherein the instructions are further executable by the processor to transmit the power management signaling by being executable to:
transmit control signaling indicating the first uplink power level and the second uplink power level.

22. The apparatus of claim 20, wherein the instructions are further executable by the processor to cause the apparatus to:
transmit, to the UE, control signaling indicating for the UE to report the first power headroom report and the second power headroom report.

23. The apparatus of claim 20, wherein the instructions are further executable by the processor to cause the apparatus to:
transmit, to the UE, control signaling scheduling an uplink transmission using the SFN configuration, wherein the first power headroom report and the second power headroom report comprise real power headroom reports associated with the uplink transmission.

24. The apparatus of claim 20, wherein the instructions are further executable by the processor to cause the apparatus to:
transmit, to the UE, control signaling scheduling an uplink transmission using a transmission configuration different from the SFN configuration, wherein the first power headroom report comprises a real power headroom report associated with the uplink transmission and the second power headroom report comprises a virtual power headroom report.

25. A method for wireless communications at a user equipment (UE), comprising:
establishing a communications link with a network via a first transmission and reception point and a second transmission and reception point according to a SFN configuration;
determining a first uplink power level for first uplink transmissions to the network via the first transmission and reception point and a second uplink power level for second uplink transmissions to the network via the second transmission and reception point; and
transmitting the first uplink transmissions to the first transmission and reception point in accordance with the first uplink power level and the second uplink transmissions to the second transmission and reception point in accordance with the second uplink power level.

26. The method of claim 25, further comprising:
receiving a DCI message indicating a first transmit power command associated with the first transmission and reception point and a second transmit power command associated with the second transmission and reception point, wherein determining the first uplink power level and the second uplink power level is based at least in part on the first transmit power command and the second transmit power command.

27. The method of claim 26, further comprising:
determining that a first field indicating the first transmit power command is associated with a first transmission configuration indicator state of a transmission configuration indicator codepoint and a second field indicating the second transmit power command is associated with a second transmission configuration indicator state of the transmission configuration indicator codepoint based at least in part on an order of the first field and the second field within the DCI message.

28. The method of claim 26, further comprising:
determining that a first field indicating the first transmit power command is associated with a first transmission configuration indicator state of a first closed loop index in a transmission configuration indicator codepoint and a second field indicating the second transmit power command is associated with a second transmission configuration indicator state of a second closed loop index in the transmission configuration indicator codepoint based at least in part on an order of the first field and the second field within the DCI message.

29. The method of claim 25, further comprising:
identifying, based at least in part on a first transmission configuration indicator state associated with the first transmission and reception point and a second transmission configuration indicator state associated with the second transmission and reception point, a first set of power control parameters associated with the first transmission and reception point and a second set of power control parameters associated with the second transmission and reception point, wherein determining the first uplink power level for the first uplink transmissions and the second uplink power level for the second uplink transmissions is based at least in part on the first set of power control parameters and the second set of power control parameters.

30. A method for wireless communications at a network entity, comprising:
establishing a communications link with a user equipment (UE) via a first transmission and reception point and a second transmission and reception point according to a SFN configuration;
transmitting, to the UE, power management signaling configured to support the UE determining a first uplink power level for first uplink transmissions to the first transmission and reception point and a second uplink power level for second uplink transmissions to the second transmission and reception point; and
receiving, from the UE at least in part in response to the transmitted power management signaling, the first uplink transmissions via the first transmission and reception point in accordance with the first uplink power level and the second uplink transmissions via the second transmission and reception point in accordance with the second uplink power level.
